(19) United States
(12) Patent Application Publication
(10) Pub. No.: US 2022/0220264 A1
(43) Pub. Date: Jul. 14, 2022

(54) HEAT-TREATED, NON-ORIENTED (CO)POLYMERIC FILMS AND METHODS FOR MAKING THE SAME USING AN ORIENTED CARRIER FILM

(71) Applicant: 3M INNOVATIVE PROPERTIES COMPANY, St. Paul, MN (US)

(72) Inventors: Aniruddha A. Upadhye, St. Paul, MN (US); Joel A. Getschel, Osceola, WI (US); Mark A. Strobel, Maplewood, MN (US); David M. Mahli, Woodbury, MN (US); Paul D. Graham, Woodbury, MN (US)

(21) Appl. No.: 17/595,205

(22) PCT Filed: May 22, 2020
(86) PCT No.: PCT/IB2020/054888

§ 371 Date: Nov. 11, 2021

Related U.S. Application Data
(60) Provisional application No. 62/855,058, filed on May 31, 2019.

(51) Int. Cl. C08J 5/18; C09J 7/29; B29C 71/02; C08J 7/04; C09J 7/40; C09J 133/02

(52) U.S. Cl. CPC C08J 5/18; C09J 7/29; C08J 7/08; C08J 7/0427; C09J 7/403; C09J 133/02; C09J 2301/162; C08J 2423/12; C08J 2425/06; C09J 2203/31; C09J 2301/302; C09J 2301/18; C08J 2367/02

(57) ABSTRACT

A heat-treated non-oriented principal film including a cast (co)polymeric component that is not capable of thermally-induced self-forming. The heat-treated principal film has first and second opposed major faces and at least one modification zone on the first major face, each modification zone including a central portion and a rim portion surrounding the central portion. Each rim portion is surrounded by a land portion. An average thickness of each rim portion is greater than an average thickness of the land portion surrounding each modification zone, and an average thickness of each central portion is less than the average thickness of the land portion, or zero. The first major face of the heat-treated principal film may be positioned in contact with an oriented carrier film including a molecularly-oriented (co)polymer that exhibits a relaxation temperature (Tᵣ). Methods of making such films and hand-tearable adhesive articles including such films are also disclosed.

### FIELD

The present disclosure relates to heat-treated, non-oriented (co)polymeric films, related hand-tearable articles (e.g., adhesive tapes, and the like), and methods for making and using such films.

### BACKGROUND

Polymeric sheets and films are used in a wide variety of configurations for a wide variety of purposes including as, for example, protective coverings and wraps, drop cloths, the backing member in adhesive tapes, etc.

Especially for sheets and adhesive tapes used in paint masking, it is required that the sheet or adhesive tape be readily torn by hand in order to provide desired degree of hand applicability and utility. Common masking tapes employ paper backings, which despite having been impregnated with saturants and binders to provide water resistance and stretch-ability still exhibit undue moisture sensitivity and are difficult to process with water-based coatings. Such tape backings also exhibit moisture instability such as cockling, buckling and shredding in certain operations such as wet sanding. Other common adhesive tape backings are based on (co)polymer films which, while providing good strength, stretch and water resistance, are often difficult to tear easily by hand. Films based on oriented (co)polymers and especially oriented polyolefins are well known as adhesive tape backings, but usually require the use of a cutting blade or knife in order to be placed into a suitable form for their ultimate use. This is not desirable or of sufficient ease of use for many applications.

It is known that using a process of rapidly heating an oriented (co)polymer film wrapped on a tooled cooling roller can produce open perforations in the film, allowing it to be readily torn by hand (see e.g., U.S. Pat. No. 7,037,100 (Strobel et al.)). It also is known to make oriented precursor films that are capable of thermally-induced elastic recovery during flame perforation. Such perforated oriented films have modification zones comprising a rim portion surrounding a central opening.

### SUMMARY

The need exists for cast films, more particularly non-oriented cast films, and articles incorporating such films (e.g., adhesive tapes), that are hand-tearable and have other desired mechanical properties, exhibit good release properties (and thus impart good unwind performance to an adhesive tape made with such films), are vapor permeable, are conformable, and the like. It has heretofore been thought to be impossible to flame perforate a non-oriented cast (co)polymeric film without obtaining undesirable damage or wrinkling of the film.

Thus, in brief summary, the present disclosure describes a family of heat-treated cast films which, in various embodiments, exhibit surprisingly good hand tear-ability and other mechanical properties, good processability, water resistance, vapor permeability, and desired conformability. Such heat-treated cast films are particularly useful as, for example, protective films and backing films for adhesive tapes and sheets, more particularly for medical adhesive tapes and films. The present disclosure provides such films, articles made with such films, and methods for making such films.

Thus, in one aspect, an article of the present disclosure includes a heat-treated principal film including a cast (co)polymeric component made up of one or more (co)polymers. The heat-treated principal film is not capable of thermally-induced self-forming (thermally-induced elastic recovery) and preferably is not molecularly oriented. The heat-treated principal film has first and second major faces, a land portion on the first major face, and one or more modification zones on the first major face. Each modification zone includes a central portion and a rim portion surrounding the central portion and being surrounded by a land portion. The average thickness of each rim portion is greater than the average thickness of the land portion surrounding the corresponding modification zone. The average thickness of each central portion is less than the average thickness of the land portion surrounding the corresponding modification zone or zero. Preferably, the average thickness of the central portion of each modification zone is from 0 micrometers (i.e., the central portion is perforated or open) to about 1 mil (about 25 micrometers).

Optionally the first major face of the heat-treated principal film is positioned in contact with an oriented carrier film including a (co)polymer selected from a polyester, polystyrene, biaxially-oriented polypropylene, or a combination thereof.

In further exemplary embodiments, substantially all of the central portions of the modification zones are perforations or openings in the heat-treated principal film, which advantageously makes the heat-treated principal film impermeable to liquids and permeable to vapors, such as air and/or water vapor.

In other exemplary embodiments, some of the central portions of the modification zones are closed and thus do not provide an opening in the film. In certain such embodiments, a majority (i.e., more than 50% by number) of the central portions are open, and a minority (i.e., less than 50% by number) of the central portions are closed, which advantageously makes the heat-treated principal film semi-permeable to vapors, such as air and/or water vapor.

The unique set of properties provided by these heat-treated cast principal films makes them well suited for many applications where they can provide many surprising advantages when used as backings for adhesive articles which exhibit hand-tearability, and which may advantageously exhibit liquid impermeability and/or vapor permeability.

In another aspect, heat-treating methods of the present disclosure include providing an oriented carrier film having opposed first and second major faces and comprising a molecularly-oriented (co)polymer that exhibits a relaxation temperature (Tᵣ) and preferably is capable of thermally-induced self-forming. The second major face of the oriented carrier film contacts a first major face of a principal film precursor comprising a cast (co)polymeric component that is not oriented and is incapable of thermally-induced self-forming. At least one female depression in a patterning surface is overlaid by at least one modification zone of the principal film precursor and the oriented carrier film. At least one modification zone of the oriented carrier film overlaying the at least one female depression in the patterning surface is heated to a temperature above the Tᵣ, while maintaining a land portion surrounding the modification zone on the first major face of the oriented carrier film and a land portion surrounding the modification zone on the first major face of the principal film precursor at a temperature below the Tᵣ, so as to cause dimensional modification of the oriented carrier film and the principal film precursor within the at least one modification zone, thereby forming a heat-treated principal film. The at least one modification zone of the oriented carrier film is then cooled to a temperature below the Tᵣ.

Each modification zone includes a central portion and a rim portion surrounding the central portion, and each rim portion is surrounded by a land portion. The average thickness of each rim portion is greater than an average thickness of the land portion surrounding each modification zone. The average thickness of each central portion is less than the average thickness of the land portion surrounding the modification zone, or zero. Thus in various exemplary embodiments, the central portions preferably may be perforated (i.e., open) with a thickness of zero, or non-perforated (i.e., closed) with a thickness that is thin (e.g., less than about 1.0 mil, or about 25 micrometers).

In some exemplary embodiments, the oriented carrier film is advantageously separated from the heat-treated principal film, for example, by delaminating the films by applying a force to the oriented carrier film and/or the heat-treated principal film in different directions.

Various unexpected results and advantages are obtained in exemplary embodiments of the disclosure. One such advantage of exemplary embodiments of the present disclosure is that a hand-tearable, non-oriented, cast (co)polymeric heat-treated principal film or sheet may be prepared. Another such advantage is that exemplary embodiments of the present disclosure may have substantially all or a portion of the central portions open (i.e., thickness of zero), and thus exhibit selective permeability to liquids and permeability to vapors such as air and/or water vapor. These and other unexpected results and advantages are within the scope of the following exemplary embodiments.

### LISTING OF EXEMPLARY EMBODIMENTS

A. An article comprising a heat-treated principal film, wherein:

the heat-treated principal film comprises a cast (co)polymeric component comprising one or more (co)polymers, wherein the heat-treated principal film is not capable of thermally-induced self-forming; and further wherein the heat-treated principal film has:
first and second opposed major faces;
a land portion on the first major face; and
one or more modification zones on the first major face, each modification zone comprising a central portion and a rim portion surrounding the central portion, and wherein each rim portion is surrounded by the land portion, wherein an average thickness of each rim portion is greater than an average thickness of the land portion, further wherein an average thickness of each central portion is less than the average thickness of the land portion surrounding each modification zone, or zero, optionally wherein the first major face of the heat-treated principal film is positioned in contact with a major face of an oriented carrier film comprising a (co)polymer selected from the group consisting of polyester, polystyrene, biaxially-oriented polypropylene, and a combination thereof.
   B. The article of Embodiment A, wherein the heat-treated principal film is not oriented.
   C. The article of Embodiment A or B, wherein each rim portion has a geometric shape selected from a circle, an ellipse, or a combination thereof.
   D. The article of any one of Embodiments A-C, wherein the optional oriented carrier film comprises a polyester (co)polymer.
   E. The article of Embodiment D, wherein the polyester (co)polymer is selected from the group consisting of poly(ethylene)terephthalate, poly(butylene)terephthalate, poly(trimethylene)terephthalate, poly(ethylene)naphthalate, poly(lactic acid), and combinations thereof.
   F. The article of any preceding Embodiment, wherein the average thickness of the land portion of the heat-treated principal film is about 0.5 to about 3 mils (13 to 75 micrometers).
   G. The article of any preceding Embodiment, wherein the cast (co)polymeric component comprises a polyolefin (co)polymer.
   H. The article of Embodiment G, wherein the polyolefin (co)polymer is an ethylene acrylic acid copolymer.
   I. The article of any preceding Embodiment, wherein the heat-treated principal film is a monolayer or a multilayer.
   J. The article of any preceding Embodiment, wherein the heat-treated principal film is heat sealable.
   K. The article of any preceding Embodiment, wherein the modification zones are arranged in an ordered array, or in a random manner.
   L. The article of any preceding Embodiment, wherein the modification zones have a substantially similar individual configuration, or a varied individual configuration.
   M. The article of any preceding Embodiment, wherein the heat-treated principal film has a first segment having a first array of a plurality of modification zones and a second segment having a second array of a plurality of modification zones, wherein the first array differs from the second array in one or more characteristics.
   N. The article of Embodiment M, wherein the characteristics are selected from the group consisting of the following: (1) an average distance between adjacent modification zones, (2) a shape of the modification zones, (3) a dimension of the modification zones, and (4) an average thickness of the rim portions.
   O. The article of any one of Embodiments A-N, wherein the heat-treated principal film has a first segment having an array of a plurality of modification zones and a second segment which is substantially free of modification zones.
   P. The article of any preceding Embodiment, further comprising an adhesive layer on one or both of the first and the second major faces of the heat-treated principal film.
   Q. The article of Embodiment P, wherein the adhesive layer comprises a pressure sensitive adhesive.
   R. The article of Embodiment P or Q, wherein the adhesive layer is discontinuous.
   S. The article of Embodiment P or Q, wherein the adhesive layer is substantially continuous.
   T. The article of any one of Embodiments P-S, wherein the adhesive layer has an average coating weight of from about 5 to about 100 g/m².
   U. The article of any one of Embodiments P-T, wherein the adhesive layer is on only the first major face or the second major face of the heat-treated principal film, and wherein a release coating is on at least a portion of the major face of the heat-treated principal film opposite the adhesive layer.
   V. The article of Embodiment U, wherein the release coating is on substantially the entire major face of the heat-treated principal film opposite the adhesive layer.
   W. An article comprising (a) a backing member having front and rear major faces, wherein (a) the article of any one of Embodiments A-O is positioned on the front or rear major face of the backing member and (b) an adhesive layer comprising a pressure sensitive adhesive is at least a portion of the major face of the backing member opposite the article of any one of Embodiments A-O.
   X. The article of Embodiment W, wherein the backing member comprises an oriented carrier film comprising a (co)polymer selected from the group consisting of polyester, polystyrene, biaxially-oriented polypropylene, and a combination thereof.
   Y. The article of Embodiment W or X, wherein the polyester (co)polymer is selected from the group consisting of poly(ethylene)terephthalate, poly(butylene)terephthalate, poly(trimethylene)terephthalate, poly(ethylene)naphthalate, poly(lactic acid), and combinations thereof.
   Z. A method for forming an article of any one of Embodiments A-Y, the method comprising:

(a) providing an oriented carrier film having opposed first and second major faces and comprising a molecularly-oriented (co)polymer that exhibits a relaxation temperature (Tᵣ), wherein the second major face of the oriented carrier film contacts a first major face of a heat-treated principal film precursor comprising a cast (co)polymeric component that is not oriented and is incapable of thermally-induced self-forming;

(b) overlaying at least one female depression in a patterning surface with at least one modification zone of the heat-treated principal film precursor and the oriented carrier film;

(c) heating the oriented carrier film in the at least one modification zone overlaying the at least one female depression in the patterning surface to a temperature above the Tᵣ, while maintaining a land portion surrounding the modification zone on the first major face of the oriented carrier film and a land portion surrounding the modification zone on the first major face of the heat-treated principal film precursor at a temperature below the Tᵣ, so as to cause dimensional modification of the oriented carrier film and the heat-treated principal film precursor within the at least one modification zone, thereby forming a heat-treated principal film; and

(d) cooling the at least one modification zone of the oriented carrier film to a temperature below the Tᵣ, wherein each modification zone of the oriented carrier film and the heat-treated principal film comprises a central portion and a rim portion surrounding the central portion and wherein each rim portion is surrounded by the land portion, further wherein an average thickness of each rim portion is greater than an average thickness of the land portion and wherein an average thickness of each central portion is less than the average thickness of the land portion surrounding the modification zone, or zero; and optionally

(e) separating the oriented carrier film from the heat-treated principal film.

AA. The method of Embodiment Z, wherein the heating is carried out using flame impingement or selectively directed infrared radiation on the first major face of the carrier film.
BB. The method of Embodiment AA, wherein the heating is carried out using flame impingement on the first major face of the carrier film and the fuel mixture is selected from the group consisting of fuel rich mixtures and fuel lean mixtures.
CC. The method of Embodiment AA, wherein the heating is carried out by applying infrared energy to the first major face of the carrier film and the first major face of the principal film precursor while cooling portions of an opposed second major face of the principal film precursor.
DD. The method of any one of Embodiments Z, AA, BB, or CC, wherein the patterning surface is a roller comprising a plurality of the at least one female depression, optionally wherein the roller is a chill roller.
EE. The method of any one of Embodiments Z, AA, BB, CC, or DD, further comprising applying an adhesive layer on one or both of the first or the second major faces of the heat-treated principal film, optionally wherein the adhesive layer comprises a pressure sensitive adhesive.
FF. The method of any one of Embodiments Z, AA, BB, CC, DD, or EE, further comprising applying a release coating on at least a portion of the first or second major face of the heat-treated principal film opposite the adhesive layer, optionally wherein the release coating is on substantially the entire major face of the heat-treated principal film opposite the adhesive layer.
GG. The method of any one of Embodiments Z, AA, BB, CC, DD, EE, or FF, wherein the oriented carrier film comprises a (co)polymer selected from the group consisting of polyester, polystyrene, biaxially-oriented polypropylene, and a combination thereof.
HH. The method of claim Embodiment GG, wherein the polyester (co)polymer is selected from the group consisting of poly(ethylene)terephthalate, poly(butylene)terephthalate, poly(trimethylene)terephthalate, poly(ethylene)naphthalate, poly(lactic acid), and combinations thereof.
II. The method of any one of Embodiments Z, AA, BB, CC, DD, EE, FF, GG or HH, wherein the cast (co)polymeric component comprises a polyolefin (co)polymer, optionally wherein the polyolefin (co)polymer is an ethylene acrylic acid copolymer.

### BRIEF DESCRIPTION OF THE DRAWINGS

The disclosure may be more completely understood by consideration of the following detailed description of various embodiments of the disclosure in connection with the accompanying figures, in which:

FIG. 1 is a schematic side view of an exemplary process for producing a hand-tearable sheet according to an exemplary embodiment of the present disclosure;

FIG. 2 is a schematic cross-sectional view of a portion of an illustrative modification zone according to an exemplary a hand-tearable sheet embodiment of the present disclosure;

FIG. 3 is a schematic plan view of the first major face of an illustrative embodiment of a hand-tearable sheet produced according to the method of the present disclosure;

FIG. 4A is a schematic cross-sectional view of a portion of an illustrative modification zone in accordance with one embodiment of the method of the present disclosure;

FIG. 4B is a schematic cross-sectional view of a portion of a different illustrative modification zone in accordance with another embodiment of the method of the present disclosure;

FIG. 5 is a perspective view of an illustrative embodiment of a roll of adhesive tape of the disclosure;

FIG. 6A is a top view of a portion of the surface of the adhesive tape shown in FIG. 5;

FIG. 6B is a top view of a portion of the surface of another embodiment of an adhesive tape in accordance with another embodiment of the present disclosure;

FIG. 7 is a graph showing the lack of constrained elastic recovery stress in a non-oriented cast precursor film according to an embodiment of the present disclosure, compared to the constrained elastic recovery stress demonstrated in comparative biaxially-oriented polypropylene films described in WO2016105501;

FIG. 8A is a photograph of a portion of the surface of a comparative cast film subjected to flame impingement differential heat-treatment without use of an oriented carrier film;

FIG. 8B is an optical microscope photograph of a portion of another comparative cast film subjected to flame impingement differential heat-treatment without use of an oriented carrier film;

FIG. 8C is an optical microscope photograph of a portion of the surface of an additional comparative cast film subjected to flame impingement differential heat-treatment without use of an oriented carrier film;

FIGS. 9A and 9B are photographs of portions of the surfaces of exemplary hand-tearable cast films subjected to flame impingement differential heat-treatment using an oriented carrier film according to embodiments of the present disclosure;

FIGS. 10A and 10B are optical microscope photographs of portions of the surfaces of exemplary hand-tearable cast films subjected to flame impingement differential heat-treatment using an oriented carrier film according to embodiments of the present disclosure.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. Therefore, it should understood that:

The term “homogeneous” means exhibiting only a single phase of matter when observed at a macroscopic scale.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g., dendritic) copolymers.

The term “(meth)acrylate” with respect to a monomer, oligomer or means a vinyl-functional alkyl ester formed as the reaction product of an alcohol with an acrylic or a methacrylic acid.

The terms “differential heating” and “localized heating” mean heating the principal film precursor such that the temperature of select portions of the principal film precursor (i.e., in an x-y perspective across the film) is raised to a level higher than the temperature of adjacent portions of the principal film. Such heating may be carried out by such means as flame impingement (e.g., as described in U.S. Pat. No. 7,037,100), selective directed infrared radiation, etc.

The term “orientable” means that the (co)polymer material, if heated above a certain temperature (T₀ or orientation temperature) and drawn, will undergo shifting and orientation of (co)polymer segments therein, and then if cooled below T₀, will retain some of the imparted orientation when subsequently released. The temperature at which a specific (co)polymer film may be oriented will depend in part upon the distribution of segments of (co)polymer materials within the film and respective melting points of components fractions in the film.

The term “oriented film” or “oriented layer” means a (co)polymeric film or layer in which the (co)polymer material has been heated above the orientation temperature (T₀) and drawn to produce at least some degree of molecular orientation of the (co)polymer chains, and subsequently cooled below T₀ so that the cooled film retains some or all of the imparted (co)polymer molecular orientation when subsequently released from tension.

The term “non-oriented film” or “non-oriented layer” means a (co)polymeric film or layer in which the (co)polymer chains are substantially in a random orientation within the film or layer. Cast films are generally considered “non-oriented films.”

The equivalent terms “thermally-induced elastic recovery” and “thermally-induced self-forming” refer to the action or response whereby a member or body of material, upon being heated to a threshold temperature (referred to herein as Tᵣ or relaxation temperature), spontaneously changes its shape or configuration, without application of external mechanical form-changing forces (e.g., gravity, embossing, molding, etc.) or without undergoing material removal effects (e.g., mechanical etching, ablation such as by laser, combustion, evaporation, etc.).

The term “flame impingement” refers to a process for differential heating of a principal film precursor wherein a heat flux in the form of a flame is directed to a first major face of a film. An illustrative example is disclosed in U.S. Pat. No. 7,037,100 (Strobel et al.).

The term “equivalence ratio” is defined as the stoichiometric oxidizer/fuel molar ratio divided by the actual oxidizer/fuel molar ratio. Flame properties are commonly correlated with the molar ratio of oxidizer to fuel. The stoichiometric ratio is the exact molar ratio of oxidizer to fuel needed for complete combustion. For “fuel-lean”, or oxidizing, flames there is more than the stoichiometric amount of oxidizer and so the flame equivalence ratio is less than one. For “fuel-rich” flames, there is less than the stoichiometric oxidizer amount present in the combustible mixture, and thus the equivalence ratio is greater than one.

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture. For purposes of clarity and without intending to be unduly limited thereby, the tape sheets or strips in a group of any two sequentially stacked sheets or strips are referenced as an overlying tape sheet and an underlying tape sheet with the adhesive layer of the overlying tape sheet adhered to the front or first face of the backing of the underlying tape sheet.

By using the term “overcoated” to describe the position of a layer with respect to a substrate or other element of an article of the present disclosure, we refer to the layer as being atop the substrate or other element, but not necessarily contiguous to either the substrate or the other element.

By using the term “separated by” to describe the position of a layer with respect to other layers, we refer to the layer as being positioned between two other layers but not necessarily contiguous to or adjacent to either layer.

The terms “about” or “approximately” with reference to a numerical value or a shape means+/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g., 1 to 5 includes 1, 1.5, 2, 2.75, 3, 3.8, 4, and 5).

Unless otherwise noted, all parts, percentages, ratios, etc. used in the specification are expressed based on the weight of the ingredients. Weight percent, percent by weight, % by weight, wt. % and the like are synonyms that refer to the amount of a substance in a composition expressed as the weight of that substance divided by the weight of the composition and multiplied by 100.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments but is to be controlled by the limitations set forth in the claims and any equivalents thereof.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

### Apparatus for Differential Heat Treatment

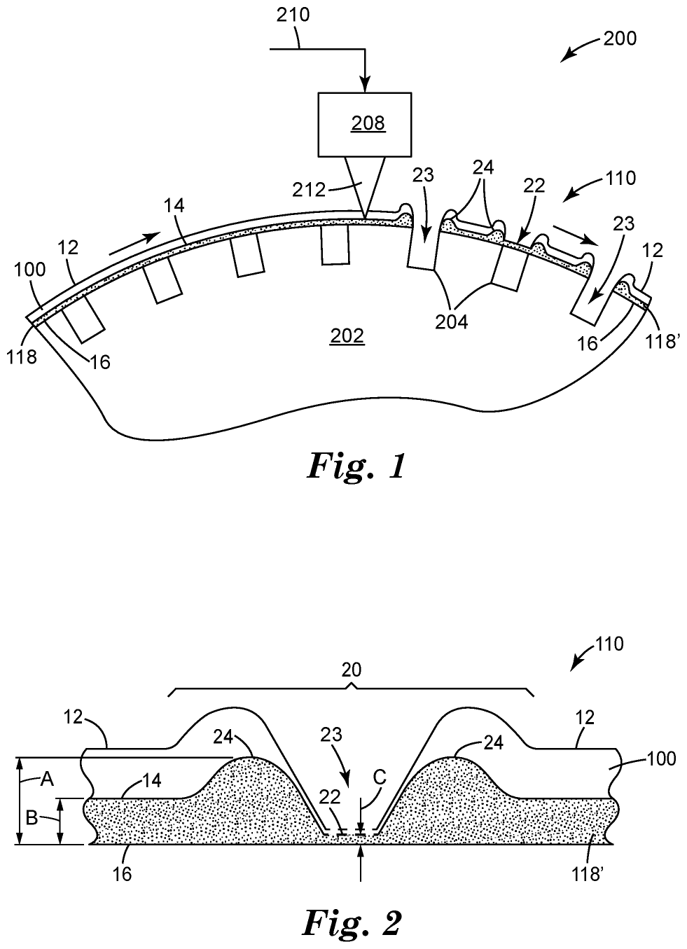

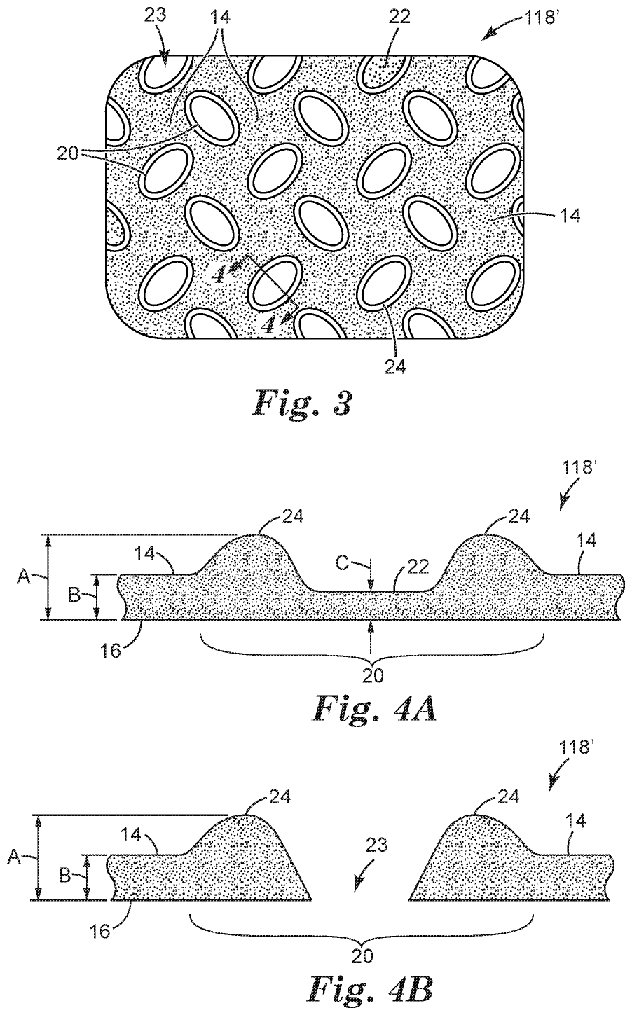

FIG. 1 illustrates an exemplary apparatus 200 and process for carrying out a flame impingement differential heat-treating process on a (co)polymeric film or layer according to the present disclosure. An oriented carrier film 100 comprising a molecularly-oriented (co)polymer, is positioned on and contacting a major face 14 (see also FIG. 3) of a principal film precursor 118, the principal film precursor 118 comprising a cast (co)polymeric component. The principal film precursor 118 exhibits a relaxation temperature (Tᵣ) but is not oriented and is incapable of thermally-induced self-forming. The lower major face 16 of the principal film precursor 118 is positioned in contact with a chilled back-up roller 202 bearing a pattern of female depressions 204.

A major face 12 of the oriented carrier film 100 on the principal film precursor 118 overlaying at least one female depression 204 in a patterning surface of the chilled back-up roller 202 is heated for a time sufficient to create at least one modification zone 20 (see FIG. 2) in the principal film precursor 118, formed as either a center opening or perforation 23, or a thin central portion 22, surrounded by a rim portion 24, thereby producing a hand-tearable, differentially heat-treated principal film 110. Heat treatment may be advantageously effected by passing major surface 12 of the oriented carrier film 100 on the principal film precursor 118 overlaying the chilled back-up roller 202 under a flame 212 created by flowing a combustion gas mixture 210 through a flame ribbon burner 208. A land portion formed by top surface 14 of the heat-treated principal film precursor 118′ adjoins each rim portion 24, as shown in more detail in FIG. 2.

### Heat-Treated Principal Films Produced Using Differential Heat Treatment

Turning now to FIG. 2, in another exemplary embodiment, the disclosure provides a hand-tearable, differentially heat-treated principal film 110 obtained by heat-treating a principal film precursor 118 comprising a cast, preferably non-oriented (co)polymeric component comprising one or more (co)polymers, wherein the principal film precursor 118 and the heat-treated principal film 110 are not capable of thermally-induced self-forming. The heat-treated principal film 118′ has first and second major faces 14 (see also FIG. 3) and 16, and one or more modification zones 20, wherein each modification zone 20 comprises a central portion 22 or 23 and a rim portion 24 surrounding the central portion 22 or 23 and being surrounded by a land portion formed by major face 14. Major surface 12 of the oriented carrier film 100 on the heat-treated principal film 118′ forms a land portion surrounding each modification zone 20 (see also FIG. 3).

The average thickness of each rim portion 24 is greater than the average thickness of the land portion of major face 14 surrounding the central portion 22 or 23. FIG. 2 shows the modification zone 20 in terms of either a center opening or perforation 23, or a thin central portion 22, surrounded by a rim portion 24.

In some exemplary embodiments, the central portion 22 or 23 has a thickness of 0 micrometers, and constitutes an opening, perforation or hole 23 extending through the heat-treated principal film 110. In other exemplary embodiments, the central portion 22 has a thickness of greater than 0 to less than the average thickness of the land area. In certain embodiments, the central portion 22 has a thickness of greater than 0 to less than, about 0.5 mils (greater than 0 to 13 micrometers, μm), 0.1 to 0.6 mil (2.5 to 15 μm), 0.2 to 0.7 mil (5 to 17.5 μm), 0.3 to 0.9 mil (7.5 to 22.5 μm), or even 0.1 to 1.0 mil (2.5 to 25 μm) or 0.1 to less than 3.0 mil (2.5 to 75 μm).

In certain exemplary embodiments, the average thickness of the land portion of the heat-treated principal film 110 is about 0.5 to about 3 mils (13 to 75 μm); 0.75 to 4 mils (about 19 to 100 μm), 1.0 to 5 mils (25 to 120 μm), or even greater than 1 mil and less than 10 mils (greater than 25 and less than 250 micrometers).

Optionally, as shown in FIG. 2, the land portion formed by first major face 14 of the heat-treated principal film 110 is positioned in contact with an oriented carrier film 100 preferably comprising a (co)polymer selected from the group consisting of polyester, polystyrene, biaxially-oriented polypropylene, or a combination thereof. In other exemplary embodiments, the oriented carrier film 100 may be separated from (e.g., delaminated from) the heat-treated principal film 110, as shown in FIG. 3 and FIGS. 4A and 4B.

FIG. 3 shows a portion of the land portion formed by major face 12 of an exemplary differentially heat-treated principal film precursor 118′ after separation from the heat-treated principal film 110 (see FIG. 2) according to an illustrative embodiment of the present disclosure, wherein the heat-treated principal film precursor 118′ is made from a suitable, preferably non-oriented, precursor film 118 (i.e., a cast film incapable of thermally-induced elastic recovery) as shown in FIGS. 1 and 2. The differentially heat-treated principal film 118′ has first major face 14 and opposite second major face 16 (see FIG. 2); one or more modification zones 20, each modification zone including a central portion 22 (closed) or 23 (open) and a rim portion 24 surrounding the central portion, and a land portion formed by major face 14 surrounding each modification zone 20.

FIG. 4A shows a cross section of a modification zone 20 of an exemplary embodiment of a heat-treated principal film precursor 118′ of the present disclosure. In accordance with the disclosure, land portion 14 surrounds the modification zone 20 which is made up of rim portion 24 surrounding central portion 22. The average thickness of rim portion 24 (dimension A) is greater than the average thickness of land portion 14 (dimension B) which in turn is greater than the average thickness of central portion 22 (dimension C). Though the profile of thickness of central portion 22 may be curved (i.e., one or both of major faces 14 and 16 may be contoured throughout central portion 22 rather than being substantially flat, as shown), dimension C is greater than zero throughout the central portion 22.

The modification zones 20 of heat-treated principal film precursors 118′ of this embodiment of the disclosure may be substantially impermeable to liquids and vapors such as air and/or water vapor, rather than having openings or through-channels extending through the thickness of the heat-treated principal film precursor 118′, such as are found in previously-known oriented films treated using flame impingement differential heating.

FIG. 4B shows a cross section of a modification zone 20 of another exemplary embodiment of a heat-treated principal film 118′ of the present disclosure. In accordance with the disclosure, land portion 14 surrounds the modification zone 20 which is made up of rim portion 24 surrounding central perforation or opening 23 extending through the thickness of the heat-treated principal film precursor 118′. The modification zones 20 of films of this embodiment of the disclosure may be substantially permeable to liquids and vapors such as air and/or water vapor. The average thickness of rim portion 24 (dimension A) is greater than the average thickness of the land portion formed by major face 14 (dimension B), which in turn is greater than the average thickness of central portion 23, which is 0 micrometers. One or both of major faces 14 and 16 may be curved rather than being substantially flat as shown in FIG. 4B.

It will be understood that FIGS. 1-3, 4A and 4B are idealized; for instance, the land portion formed by the major face of the film 14 may not be flat, and/or the opposite major face 16 of the heat-treated film principal film precursor 118′ may not be flat. Depending in part upon the nature of the precursor film and manner of carrying out differential heating, the modification zone 20 may comprise some thickening and protrusion of the film on its second major face 16 for the embodiment shown in FIG. 4A.

In accordance with the disclosure, land portions 14 surround each modification zone 20, which are made up of rim portion 24 surrounding each corresponding central portion 22 or 23. The average thickness of rim portion 24 (dimension A) is greater than the average thickness of land portion 18 (Dimension B) which in turn is greater than the average thickness of central portion 22 (dimension C).

Dimension C may be zero or greater than zero throughout the central portions 22 or 23. Preferably, each modification zone 20 includes a central portion 22 or 23 having an average thickness from 0 to less than the thickness of the dimension B. The modification zones 20 of heat-treated principal films 110 of the embodiment shown in FIG. 4B of the disclosure preferably include one or more perforations or openings 23 extending through the heat-treated principal film precursor 118′ in central portion 23, rather than being closed 22.

In some exemplary embodiments, substantially all of the central portions 22 or 23 of the modification zones 20 comprise perforations or openings 23 extending through the film, which advantageously makes the film substantially permeable to vapors, such as air and/or water vapor.

However, in other exemplary embodiments, at least some of the central portions 22 or 23 of the modification zones 20 are closed 22 and thus do not provide an opening 23 extending though the film. In certain such embodiments, a majority (i.e., more than 50% by number) of the central portions 22 or 23 are preferably open 23, and a minority (i.e., less than 50% by number) of the central portions 22 or 23 are closed 22, which advantageously makes the film semi-permeable to vapors, such as air and/or water vapor, yet substantially impermeable to liquids.

Such films can be used advantageously as paint masking adhesive tape backings or sheeting, medical tape backings, and can be used in liquid coating processes. Films of the disclosure in addition exhibit good tear properties, good strength, good conformability and stretch, excellent water resistance as well as low unwind when used as a roll of adhesive coated tape. In addition, the structure imparted by the thermal modification process results in an adhesive tape or sheet which is easier to handle due to the relative increase in thickness or loft of the film as well as the texture thus imparted.

For many embodiments in which easy hand-tearing is desired, it is sometimes preferred that the resultant heat-treated principal film exhibit an un-notched tear strength of about 100 gram-force (g_{f})/mil-thickness or less, more preferably about 70 g_{f}/mil-thickness or less, and most preferably about 55 g_{f}/mil-thickness (e.g., in the transverse direction of a tape). If the film's tear force is too high then the film may be unduly difficult to tear by hand, though in some applications of films of the disclosure this may be acceptable.

The unique set of properties provided by these flame perforated cast films makes them well suited for many applications where they can provide many surprising advantages as backings for adhesive articles which exhibit hand-tearability, and which may advantageously exhibit liquid impermeability and/or vapor permeability or semi-permeability.

### Processes for Heat Treatment to Form Hand-Tearable Films

In further exemplary embodiments, the disclosure provides processes using the heat-treating apparatus 200 and techniques that provide heat-treatment to cast (non-oriented) principal film precursors 118 to produce heat-treated cast (non-oriented) principal films 110 including one or more modification zones 20 with rims 24, and thin recessed closed central portions 22 or open central portions 23. The processes include the steps of:

(a) providing an oriented carrier film having opposed first and second major faces and comprising a molecularly-oriented (co)polymer that exhibits a relaxation temperature (Tᵣ), wherein the second major face of the oriented carrier film contacts a first major face of a principal film precursor comprising a cast (co)polymeric component that is not oriented and is incapable of thermally-induced self-forming;

(b) overlaying at least one female depression in a patterning surface with at least one modification zone of the principal film precursor and the oriented carrier film;

(c) heating the oriented carrier film in the at least one modification zone overlaying the at least one female depression in the patterning surface to a temperature above the Tᵣ, while maintaining a land portion surrounding the modification zone on the first major face of the oriented carrier film and a land portion surrounding the modification zone on the first major face of the principal film precursor at a temperature below the Tᵣ, so as to cause dimensional modification of the oriented carrier film and the principal film precursor within the at least one modification zone, thereby forming a heat-treated principal film; and

(d) cooling the at least one modification zone of the oriented carrier film to a temperature below the Tᵣ, wherein each modification zone of the oriented carrier film and the heat-treated principal film comprises a central portion and a rim portion surrounding the central portion and wherein each rim portion is surrounded by the land portion, further wherein an average thickness of each rim portion is greater than an average thickness of the land portion and wherein an average thickness of each central portion is less than the average thickness of the land portion surrounding the modification zone, or zero.

In some exemplary embodiments, the oriented carrier film is advantageously separated from the heat-treated principal film, for example, by delaminating the films by applying a force to the oriented carrier film and/or the heat-treated principal film in different directions.

Heating to create at least one modification zone 20 in the principal film precursor 118, may be carried out using a variety of methods. In some exemplary embodiments, heating is carried out using flame impingement or selectively directed infrared radiation on a major face of the carrier film. Preferably, the oriented carrier film 100 on the principal film precursor 118 overlaying the at least one female depression 204 is passed under a flame 212 created by flowing a combustion gas mixture 210 through a flame ribbon burner 208. Preferably, heating is carried out using flame impingement on the external major face of the carrier film and the fuel mixture is selected from the group consisting of fuel rich mixtures and fuel lean mixtures, as described further below. The outer surface of the oriented carrier film 100 on the principal film precursor 118 overlaying the at least one female depression 204 is preferably exposed to the flame 212.

In other exemplary embodiments, heating is carried out by applying infrared energy to the major face of the oriented carrier film and the principal film precursor while cooling portions of an opposed major face of the principal film precursor overlaying at least one female depression 204 in the patterning surface 202.

In any of the foregoing embodiments, the patterning surface 202 may be a roller comprising a major face having a plurality of the female depressions 204, as shown in FIG. 1. Preferably the roller is a chill roller, that is, a roller maintained at a temperature less than the temperature of the principal film precursor 118 in order to effect cooling of the principal film precursor 118 to a temperature below the heat-treatment temperature. The surface temperature of the chill roller may advantageously be maintained at a temperature of from 0° C. to 30° C., more preferably 5° C. to 25° C., 10° C. to 20° C., or any combination thereof. In some embodiments, it may be advantageous to maintain the surface of the chill roller at a temperature above the dew point of water vapor to avoid water condensation on the surface of the chill roller.

In some exemplary embodiments, each rim portion has a geometric shape selected from a circle, an ellipse, or a combination thereof. Furthermore, it is not necessary for each of the modification zones to be wholly identical to the others or absolutely precise in shape, size, or openness. Many techniques and apparatus known in the art for flame treatment can be employed in the present disclosure. As they do when used for conventional differential flame treating, when used to form modification zones in accordance with the disclosure, such techniques and apparatus will yield heat-treated principal films having modification zones that vary somewhat in size and perfection of shape, but which nevertheless are hand-tearable.

Certain surprising aspects of the present disclosure are more easily achieved with an understanding of the effective equivalence ratio used in flame impingement heat-treating processes, and effective exploitation thereof.

In a fuel-rich flame, the overall environment in which the film is exposed to the flame is primarily reducing in nature because of the high concentration of hydrogen atoms, carbon monoxide, and hydrocarbon free radicals, yet some oxidation of the film occurs because there are some oxidizing species still present in the flame product gases. In contrast, in a fuel-lean flame such as is taught in the art for the surface treatment of (co)polymers to impart higher adhesion properties thereto, the overall environment is highly oxidizing because of the high concentrations of oxygen molecules and hydroxyl radicals.

Flame impingement to carry out differential heating and modification of the principal film precursor 118 to form heat-treated principal film 110 including heat-treated principal film precursor 118′ in accordance with the disclosure requires relatively high flame powers to modify and differentially heat the (co)polymer film at commercially desirable film speeds. For example, flame powers of at least about 10,000 Btu/hr per inch of cross-web burner length (1160 Watts/cm) are typically desirable to enable differential heating at speeds of from about 20 to over 100 meters/min. When using the fuel-lean flames that are taught in the art as optimal for the flame processing of (co)polymers, such conditions of high flame power and relatively low film speed cause significant oxidation of the (co)polymer surface. When a (co)polymer surface is relatively highly oxidized, wettability of that surface is typically high. Thus, if a fuel-lean flame is used for flame impingement, the resulting rims are oxidized to such an extent that the pressure-sensitive adhesives tend to adhere more strongly to the rims, thereby interfering with and in some instances preventing unwind of the tape. We have found that undesired oxidation of the (co)polymer rim surface can be limited by using low-power fuel-lean flames (for example, at powers of less than about 5000 Btu/hr-in.). However, when using such low-power flames, it is not possible to effectively modify the film at commercially viable film speeds.

It is surprising that fuel-rich flames can be used at sufficiently high powers to enable differential heating sufficient to achieve desired thermally-induced self-forming at film speeds of more than about 20 meters/min, but without causing the excessive oxidation of the rims that might prevent smooth and easy unwinding of, for instance, finished tape made with such heat-treated principal films 110.

The method and process conditions used to carry out formation of modification zones are selected in part based upon the desired modification zones and nature of the films. It is typically preferred that the process be carried out so as to minimize the degree of thermal damage the film undergoes aside from formation of the desired modification zones.

Passing the web through the flame impingement station at higher speed generally results in formation of relatively smaller modification zones. As will be understood by those skilled in the art, other flame impingement conditions used (such as the flame power, the burner-to-film separation, or backing roller patterns) can be adjusted to attain similar modification zone sizes and spacing or any desired array of modification zones.

The pattern of female depressions (sometimes referred to as indentations, wells, or dimples) in the backing roller that are used to achieve the desired differential heating determines in part the arrangement and dimensions of the resultant modification zones with each modification zone corresponding to a dimple or depression in the backing roller. In some instances, the modification zones are arranged in an ordered array. In some instances, the modification zones are arranged in a random manner. If desired, the modification zones may have substantially similar individual configuration (i.e., from using backing rolls with depressions that are substantially similar in shape and dimension), or the modification zones may have varied individual configuration (i.e., from using backing rolls having depressions that vary accordingly in shape, dimension, or both).

Flame impingement heat treating can be performed by, for example, the process specification given for Example 1 of U.S. Pat. No. 7,037,100. Such apparatus ordinarily employs premixed laminar flames in which the fuel and the oxidizer are thoroughly mixed prior to combustion. However, in contrast to the process described in U.S. Pat. No. 7,037,100, in some embodiments of the present disclosure a fuel-rich flame is used. According to the properties desired of the resultant film, the flame impingement process may be carried out so as to impart desired surface characteristics (e.g., using a relatively fuel rich mix when increased release tendencies are desired (e.g., to achieve release with reduced or eliminated release agent) as opposed to using a relatively fuel lean mix when increased bonding tendencies are desired).

As shown schematically in FIG. 2, the major face 12 of the oriented carrier film 100 that is exposed to the flame during formation of the modification zones 20 generally develops the rims 24 of (co)polymer material that surround the central portion 22 or 23. However, a rim may also form in that portion of the principal film precursor 118 that underlies each rim 24 formed in each modification zone 20. Furthermore, in some exemplary embodiments, the rim portion 24 of the modification zone 20 may be made up of protrusion of the film outwardly (i.e., z-axis) from any or all of major face 12 of the oriented carrier film, major face 14 of the heat-treated principal film 110, and major face 16 of the heat-treated principal film 110.

In some exemplary embodiments, rims may effectively act as a release surface for an adhesive subsequently applied to the opposite side by minimizing the contact between the backing member and the adhesive when wound into the common roll form of tape. In instances where it is important that the rim surface exhibit release properties, it may be important that the process for formation of modification zones be performed by using flame conditions that do not overly oxidize the first major face of the film in either the raised rims or surrounding land portion; that is, by using flame conditions that minimize the adhesion-promoting characteristics of the surface oxidation typically caused by exposure to a flame.

While flame-induced surface oxidation cannot be totally eliminated, oxidation is maximized at a flame equivalence ratio of 0.92 to 0.96 but minimized at flame equivalence ratios of at least about 1.05, which are fuel-rich flames [See C. Stroud et al., Progress in Energy and Combustion Science, 34 (6), 696-713 (2008)]. It is therefore necessary to conduct the flame impingement process using a fuel-rich flame, preferably with an equivalence ratio of about 1 and preferably at least about 1.05. Use of fuel-rich flames for flame perforating cast (co)polymer films is contrary to essentially all recommendations in the art of flame treating. The advantages obtained from using such backing members (e.g., improvement in unwind performance of the tape roll form, resistance to paint penetration, etc.) are surprising and unexpected outcomes from this processing choice.

It is known from the relevant art (e.g., from U.S. Pat. No. 7,037,100 and the like) that oriented (co)polymeric films can be exposed to a high heat flux source such as a flame while wrapped on a cooled tooled backing roller, causing differential heating of the two major faces. It is thought that the exposure of the film sections directly spanning a tooled indentation in the cooled backing roller causes a very rapid heating of that film section which causes a sudden, uncontrolled release or relaxation of the film orientation and results in a perforation being formed with associated ‘rim’ material at the margins of the perforation opening, comprising the mass of relaxed (co)polymer molecules caused by this shrinkage. This process is termed thermally induced elastic recovery. The present disclosure relates to the surprising discovery that, by using oriented carrier films in conjunction with cast precursor films in a heat-treating process as a described herein, modification zones with open central portions can be formed in non-oriented cast films,

which heretofore could not be achieved by heat-treating non-oriented cast films.

Materials

Principal Film Precursors and Heat-Treated Principal Films

Films suitable for use as principal film precursors of the disclosure should generally be incapable of thermally-induced self-forming. Preferably, the principal film precursor and the heat-treated principal film are not oriented.

Precursor films useful to make conformable, hand-tearable heat-treated principal films and articles of the disclosure are typically cast films, preferably non-oriented cast films, more preferably non-oriented cast films comprising a crystalline or semi-crystalline (co)polymer.

In some exemplary embodiments, the principal film precursors comprise cast (preferably non-oriented) polyolefin (co)polymers (e.g., polypropylene, polyethylene, etc., or combinations thereof). In addition, virtually any (co)polymeric films incapable of thermally-induced elastic recovery can be made from other materials (e.g., polyester, polystyrene, polyamide, etc.) and advantageously used in practicing the processes of the present disclosure. In some presently-preferred embodiments, the polyolefin (co)polymer is an ethylene acrylic acid copolymer.

In other exemplary embodiments, the heat-treated principal film may be in the form of a single layer (i.e., a monolayer) or a multilayer. In further exemplary embodiments, the heat-treated principal film is heat sealable.

Carrier Films

Carrier films suitable for use in practicing certain exemplary methods of the present disclosure should generally be oriented films capable of thermally-induced self-forming. Carrier films useful to make conformable, hand-tearable flame impingement differentially heat-treated principal films and articles of the present disclosure typically are oriented, cast films comprising at least one crystalline or semi-crystalline (co)polymer.

Suitable crystalline or semi-crystalline (co)polymers for use in the carrier film are known to those skilled in the art, and many are commercially-available. Examples of suitable crystalline or semi-crystalline (co)polymers include block or random polyolefin copolymers; blends of polyolefin (co)polymers with one or more other (co)polymers having reduced or lower melting crystallite components, and polyester (co)polymers.

Examples of suitable commercially-available materials polyolefin (co)polymers include ENGAGE™ 8401 and 8402, AFFINITY™ 820, and INFUSE™ 9507, (all from Dow Chemical Co., Midland, Mich.); VISTAMAXX™ 6202 (from ExxonMobil Chemical Co.); MF 502 matte polyolefin homopolymer (available from A. Schulman Co., Akron Ohio; polypropylene (PP) homopolymers (available from Mayzo Co., Suwanee, Ga.); and PP 4792, a polypropylene homopolymer resin (available from Exxon-Mobil Co., Houston, Tex.).

Polyester (co)polymers can be particularly advantageous for use in the carrier film. Presently preferred polyester (co)polymers can be selected from poly(ethylene)terephthalate, poly(butylene)terephthalate, poly(trimethylene)terephthalate, poly(ethylene)naphthalate, poly(lactic acid), and combinations thereof.

The processes used to produce oriented (co)polymer films are well known and can be typically accomplished using blown film or tenter-stretched film processes. For reasons of economy and uniformity the tenter stretching process is most widely employed to produce films for adhesive tape backings, typically in the range from about 10 micrometers up to about 75 micrometers or more in thickness. Tenter stretching can be accomplished using either sequential or simultaneous stretching processes; the sequential stretching process is by far the most popular. In a typical sequential process, a film is produced by stretching first in the length direction, referred to as the LO; then in the transverse direction referred to as the TDO. In a simultaneous stretching process, the film is stretched concurrently in both the LO and TDO.

Sequential tenter stretching entails melting and casting the (co)polymer resin onto a chilled casting roller, then transporting the sheet to a first length orientation section. It is desirable to cast the film at a low temperature with maximum quenching, which retards the growth of large crystalline morphology and thereby produces the highest clarity and strength film.

Length orientation (LO) is usually accomplished by passing the cast sheet over a series of heated contact rolls that are driven at differential speed, thereby both heating and stretching the film in the length direction. Typical LO ratios are about 4 or 5/1 times. Following the LO step, the partially stretched film is then fixture along the edges using a series of tenter clips attached to the tenter stretching frame and then transported into the tenter oven. The tenter oven is usually heated to temperatures up to about the crystalline melting point temperature, allowing the film to soften sufficiently to allow transverse direction (TD) stretching to a ratio of about 8/1 to about 10/1.

Stretching a cast sheet at too low of a temperature requires very high forces and often results in the film tearing or breaking, especially in the tenter oven. Stretching a film at too high a temperature above the crystalline melting point results in the film exhibiting poor retained orientation as well as caliper defects caused by droop or sag in the tenter stretching process. See R. A. Phillips & T. Nguyen, J. Appl. Polym. Sci., v. 80, 2400-2415 (2001); and P. Dias et al., J. Appl. Polym. Sci., v. 107, 1730-1736 (2008). It is desirable to stretch the cast sheet at a temperature that allows for low force stretching but that also is below the melting point of the (co)polymer so that the film exhibits a high degree of molecular orientation, which is preferred for strength and dimensional stability in use.

In some embodiments, the oriented carrier film is a sequential tenter-stretched film exhibit an elastic recovery lower than about −2.0 N/m² as measured in the transverse film direction (TD) using a DMA. In some embodiments, precursor films used in accordance with the disclosure exhibit an initial tensile modulus in the transverse direction of less than about 2500 MPa as measured by Instron.

Illustrative examples of (co)polymeric carrier films useful in this disclosure include any (co)polymer film capable of thermally induced elastic recovery, including polyolefins, polyesters, glassy (co)polymers such as polyvinyl chloride and polystyrene, acrylic (co)polymers, etc. Preferably the (co)polymer films are oriented in at least one major direction (that is, LO or TDO meaning Length Orientation or Transverse Direction Orientation). Such oriented films are believed to provide a balance of toughness and ease of hand tearing once subjected to the differential thermal heating process.

Preferred carrier films include sequentially or simultaneously biaxially oriented polyolefins comprising one or more component polyolefin resins and combinations of resins. Such film may in addition comprise more than one layer, preferably 2, 3, 5, 7 or more layers. Sequential or simultaneous biaxial orientation is preferably carried out using a tenter stretching process but may in addition be carried out by roller stretching, blown film stretching, or combinations thereof.

In an embodiment, a (co)polymer film carrier may comprise blends or layers including one (co)polymer resin having a melting point below the stretching or drawing temperature. Such lower melting components may be incorporated at any useful level, but typically comprise between about 5 to 95 weight % of the total.

In another embodiment a (co)polymer carrier film may comprise blends of semi-crystalline and amorphous components in any combination. Component materials may include random or block copolymers or may include physical dispersions of semi-crystalline or amorphous phases of one or more materials.

In yet another an embodiment a (co)polymer carrier film may comprise a multilayer film in which at least one major face layer is a higher melting (co)polymer relative to base or core layers. In such films exposure to the differential thermal heating process may result in desirable structures on one or both major faces which may be useful for example in providing texture, adhesive release, liquid impermeability or the like.

In further embodiments a (co)polymer carrier film may comprise a multilayer film in which at least one major face layer is a lower melting (co)polymer relative to base or core layers. Such films may be advantageous in providing softer surface layers yet still provide good liquid impermeability.

In an embodiment a film comprising multilayers including a surface layer comprising PP 9122 random propylene copolymer from Exxon-Mobil and a second base layer greater in thickness than the surface layer, comprising PP 5571 impact polypropylene was biaxially oriented in a sequential tenter stretching process to produce a film which exhibited very good hand tear-ability, good conformability, defined as the ability to form a tight radius when applied as an adhesive tape, good opacity and liquid impermeability.

Carrier films of the disclosure typically comprise one or more (co)polymer, in particular oriented polyolefins and their blends. The term ‘polyolefin’ may constitute but is not limited to, (co)polymers of ethylene, propylene, butylene etc. as well as their random and/or block copolymers and blends. Optionally such films may constitute more than one layer, as for example, 2, 3, 5, 7 or higher numbers of layers. In this fashion different extents of thermally-induced elastic recovery may occur in different layers to produce films having novel and useful properties. Other films may be produced from (co)polymers such as polyesters, polystyrenes or other (co)polymers capable of forming oriented films. Non-oriented films may also be contemplated, providing their thickness permits hand tear-ability after exposure to the differential heating process described herein. In most cases non-oriented cast sheets exhibit a high tear force and produce irregular or non-straight tearing.

Carrier films useful in the present disclosure may contain one or more components or layers in which the component or layer material is oriented at a temperature about equal to or greater than the component or layer melting point. It is thought that under such stretching conditions, the component material is considered to experience ‘warm’ or ‘hot’ drawing, which imparts a low degree of orientation in the film thereby limiting sufficient elastic recovery to form through-thickness perforations in the differential heating process.

It is believed that in such cases, the (co)polymer molecule orientation induced by the stretching process is either relaxed during the process as for example can occur with amorphous components, or that the oriented (co)polymer molecules, being semi-crystalline but having a lower melting temperature than the stretching process temperature, can re-crystallize in less oriented state upon cooling. cf. J. Appl Polm Sci references cited above. Such films while not exhibiting perforations completely through the film thickness, still exhibit surprisingly good hand tear-ability.

It is believed that elastic recovery in oriented (co)polymers controls carrier film shrinkage and is related to the non-crystalline or amorphous ‘tie chains’ present in oriented semi-crystalline (co)polymers (See I. M. Ward et al., J. Appl. Polym. Sci., v. 41, 1659 (1990); and Structure and Properties of Oriented Polymers, ed. by I. M. Ward, Chapman and Hall, London (1997). On a molecular level, the elastic recovery arises from recoiling of the (co)polymer chains that were extended in the stretching process, resulting from melting of the crystalline component that served to hold the strained chains in place.

Elastic recovery is also believed related to the film making process conditions, especially the temperature of film casting (that is, the quenching or casting temperature) and the temperature of stretching. The casting temperature dictates the starting morphology of the semi-crystalline (co)polymer structure and is believed to influence the volume of tie chain material present during subsequent stretching. At low casting temperatures, crystallization is very rapid and produces many smaller crystallites and a larger volume of tie chains. At higher casting temperatures near to the melting point of the (co)polymer, crystallization is less rapid and produces fewer larger crystallites with a smaller volume of tie chains. (See Capt, L., et al. “Morphology Development during Biaxial Stretching of Polypropylene Films.” 17^{th} Polymer Processing Society Annual Meeting (2001).)

So-called taut tie chains present in stretched semi-crystalline (co)polymers are believed to be responsible for elastic recovery of the stretched (co)polymer carrier films when exposed to heat (See B. Alcock et al. “The effect of processing conditions on the mechanical properties and thermal stability of highly oriented PP tapes,” Europ. Polym. J., 45 (2009): 2878-2894.).

Optional Additives

The principal film precursors, heat-treated principal films and/or carrier films of the present disclosure may optionally include one or more additives and other components as is known in the art. For example, the backing member or component members thereof may contain fillers, pigments and other colorants, antiblocking agents, lubricants, plasticizers, processing aids, antistatic agents, nucleating agents (e.g., beta nucleating agents), antioxidants and heat stabilizing agents, ultraviolet-light stabilizing agents, and other property modifiers (e.g., agents to improve compatibility, increase or decrease bonding properties, etc. with desired adhesives and other materials). Fillers and other additives are preferably added in an amount selected so as not to adversely affect the properties attained by the preferred embodiments described herein.

Illustrative examples of organic fillers include organic dyes and resins, as well as organic fibers such as nylon and polyimide fibers, and inclusions of other, optionally crosslinked, (co)polymers such as polyethylene, polyesters, polycarbonates, polystyrenes, polyamides, halogenated (co)polymers, poly (meth)acrylates, cyclo-olefin (co)polymers, and the like. Illustrative examples of inorganic fillers include pigments, fumed silica and other forms of silicon dioxide, silicates such as aluminum silicate or magnesium silicate, kaolin, talc, sodium aluminum silicate, potassium aluminum silicate, calcium carbonate, magnesium carbonate, diatomaceous earth, gypsum, aluminum sulfate, barium sulfate, calcium phosphate, aluminum oxide, titanium dioxide, magnesium oxide, iron oxides, carbon fibers, carbon black, graphite, glass beads, glass bubbles, mineral fibers, clay particles, metal particles, and the like.

In some applications it may be advantageous for voids to form around the filler particles during an orientation process or use entrained blowing agents to form voids. Organic and inorganic fillers may also be used effectively as antiblocking agents. Alternatively, or in addition, lubricants such as polydimethyl siloxane oils, metal soaps, waxes, higher aliphatic esters, and higher aliphatic acid amides (such as erucamide, oleamide, stearamide, and behenamide) may be employed.

The principal film precursors, heat-treated principal films and/or carrier films of the present disclosure may contain antistatic agents, including aliphatic tertiary amines, glycerol monostearates, alkali metal alkanesulfonates, ethoxylated or propoxylated polydiorganosiloxanes, polyethylene glycol esters, polyethylene glycol ethers, fatty acid esters, ethanol amides, mono- and diglycerides, and ethoxylated fatty amines. Organic or inorganic nucleating agents may also be incorporated, such as dibenzylsorbitol or its derivatives, quinacridone and its derivatives, metal salts of benzoic acid such as sodium benzoate, sodium bis(4-tert-butyl-phenyl)phosphate, silica, talc, and bentonite.

Antioxidants and heat stabilizers can further be incorporated, including phenolic types (such as pentaerythrityl tetrakis [3-(3,5-di-tert-butyl-4-hydroxyphenyl)propionate] and 1,3,5-trimethyl-2,4,6-tris(3,5-di-tert-butyl-4-hydroxybenzyl)benzene), and alkali and alkaline earth metal stearates and carbonates. Other additives such as flame retardants, ultraviolet-light stabilizers, compatibilizers, antimicrobial agents (e.g., zinc oxide), electrical conductors, and thermal conductors (e.g., aluminum oxide, boron nitride, aluminum nitride, and nickel particles) may also be blended into the (co)polymers used to form the tape backing member.

Additives, fillers, pigments, dyes, UV stabilizers, and nucleating agents may be useful components of the principal film precursors, heat-treated principal films and/or carrier films in the practice of this disclosure. Relative proportions and methods of inclusion are well known to those skilled in the art.

Optional Adhesives

In some exemplary embodiments, the heat-treated principal film may be useful as a backing member in an adhesive article. In such embodiments, at least one major face of the heat-treated principal film is preferably coated with an adhesive material, more preferably a pressure sensitive adhesive.

The adhesive may be any suitable adhesive as is known in the art. Preferred adhesives are normally tacky, pressure sensitive adhesives. Selection of adhesive will be dependent in large part upon the intended use of the resultant tape. Illustrative examples of suitable adhesives include those based on (meth)acrylate (co)polymers, rubber resins such as natural rubber, butyl rubber, styrene copolymers, etc., silicones, and combinations thereof. The adhesive may be applied by solution, water-based or hot-melt coating methods. The adhesive can include hot melt-coated formulations, transfer-coated formulations, solvent-coated formulations, and latex formulations, as well as laminating, thermally-activated, and water-activated adhesives and are not limited except so as to provide a desirable balance of tape roll unwind and adhesion properties.

Illustrative examples of tackified rubber hot melt adhesives that are suitable for use in tapes of the disclosure are disclosed in U.S. Pat. Nos. 4,125,665, 4,152,231, and 4,756,337. Illustrative examples of acrylic hot melt adhesives that are suitable for use in tapes of the disclosure are disclosed in U.S. Pat. Nos. 4,656,213 and 5,804,610.

In certain embodiments, a low adhesion backsize (“LAB”) comprising a low surface energy release material such as a polysiloxane (co)polymer, a highly-fluorinate (co)polymer such as a perfluoro-(co)polymer, or a side chain crystallizable (meth)acrylate (co)polymer, may be advantageously applied to an opposing major face of the heat-treated principal film opposite the adhesive material.

In other exemplary embodiments, a release liner comprising a low adhesion backsize (“LAB”) including a low surface energy release material such as a polysiloxane (co)polymer, a highly-fluorinate (co)polymer such as a perfluoro-(co)polymer, or a side chain crystallizable (meth)acrylate (co)polymer, may be positioned adjacent to and adjoining an opposing major face of the heat-treated principal film opposite the adhesive material. The use of a release liner is particularly advantageous when it is desirable to wind the heat-treated principal film into roll form, for example, for use as an adhesive tape.

Those skilled in the art will be able to select suitable adhesives and release materials for use in the disclosure, dependent in large part upon the desired application.

Those skilled in the art will be able to select rotary rod or other suitable coating techniques for applying adhesive and/or a release material to a major face of the heat-treated principal film for use in articles of the present disclosure. Selection of the coating method will be dependent in part upon the flow characteristics of the adhesive, desired penetration of adhesive into perforations, etc. Those skilled in the art will be able to readily select suitable methods for applying or coating adhesive on the sheet. Illustrative examples include rotary rod die coating, knife coating, drop die coating, etc. Illustrative examples of rotary rod coating methods that may be used to make tapes of the disclosure are disclosed in U.S. Pat. Nos. 4,167,914, 4,465,015, and 4,757,782.

To enhance adhesion between the backing member and the adhesive, adhesion promoting treatment(s) may be applied to the second major face of the backing member, e.g., flame treatment under fuel-lean conditions, exposure to corona, chemical primers, etc.

Pressure sensitive adhesives are well known to possess aggressive and permanent tack, adherence with no more than finger pressure, and sufficient ability to hold onto an adherend.

Additionally, the adhesives can contain additives such as tackifiers, plasticizers, fillers, antioxidants, stabilizers, pigments, diffusing materials, curatives, fibers, filaments, and solvents.

In some embodiments, the adhesive optionally can be cured by any suitable method to modify the properties thereof including rendering it less likely to flow. In particular the crosslinking level can be chosen so as to provide a balance of good tape roll unwind and finished adhesive properties. Typical crosslinking can be provided by well-known methods such as radiation-induced crosslinking (for example, UV or e-beam); thermally induced crosslinking, chemically reactive crosslinking or combinations thereof.

The adhesive may be applied in any desired amount, and typically is applied to provide a conventional dry coating weight between about 5 to about 100 g/m². Thicker adhesive coatings tend to increase probability of causing undesirable increases in unwind force. Too thin coatings are not functional or tend to wet substrate surfaces poorly.

A general description of useful pressure sensitive adhesives may be found in the Encyclopedia of Polymer Science and Engineering, Vol. 13, Wiley-Interscience Publishers (New York, 1988). Additional description of useful pressure sensitive adhesives may be found in the Encyclopedia of Polymer Science and Technology, Vol. 1, Interscience Publishers (New York, 1964).

Following application of adhesive to the backing member, tape of the disclosure may be converted to desired configurations using known approaches, e.g., slitting, rolling, etc. Sheets of tape of the disclosure may be wound into roll form (e.g., one or more sheets of the tape wound upon itself about an optional core) or stacked in sheet form. In accordance with the disclosure, surprising advantages provided by such tape assemblies include easy unwind as the interface between the adhesive layer of overlying plies and first major face with raised rims of the heat-treated principal film of underlying plies separate easily, as well as good hand tear, conformability, and other tape properties.

### Films and Adhesive Tapes

The heat-treated principal films of the present disclosure can be used to manufacture tapes or sheets, which may be adhesive-backed or not, for many applications including packaging tapes, paint masking tapes, general utility or “duct” tapes, medical tapes, masking films, liners, wraps, as well as laminates with one or more additional layers including nonwovens, foams, etc.

Adhesive Tapes

The heat-treated principal films, alone or optionally in combination with the carrier film, may be used advantageously as a backing in an adhesive tape. In some exemplary embodiments, the adhesive tape comprises an adhesive layer on one or both of the first and the second major faces of the heat-treated principal film. In certain such embodiments, the adhesive layer comprises a pressure sensitive adhesive.

In some advantageous embodiments, the adhesive layer is discontinuous. In other advantageous embodiments, the adhesive layer is substantially continuous. Generally, the adhesive layer has an average coating weight of from about 5 to about 100 g/m²; 10 to 90 g/m², 15 to 75 g/m², or even 20 to 50 g/m².

In certain exemplary embodiments, the adhesive layer is positioned on only the first major face or the second major face of the heat-treated principal film. In certain such embodiments, a release coating may be advantageously applied on at least a portion of the major face of the heat-treated principal film opposite the adhesive layer. In some such embodiments, the release coating is applied on substantially the entire major face of the heat-treated principal film opposite the adhesive layer.

In further exemplary embodiments, the heat-treated principal film and overlaying oriented carrier film make up a backing member having front and rear major faces, and an adhesive layer, preferably comprising a pressure sensitive adhesive, is applied to at least a portion of the major face of the oriented carrier film or the heat-treated principal film forming the backing member. In certain such embodiments, the oriented carrier film advantageously comprises a (co)polymer selected from the group consisting of polyester, polystyrene, biaxially-oriented polypropylene, and a combination thereof. In some such embodiments, the polyester (co)polymer is advantageously selected from the group consisting of poly(ethylene)terephthalate, poly(butylene)terephthalate, poly(trimethylene)terephthalate, poly(ethylene)naphthalate, poly(lactic acid), and combinations thereof. In additional such embodiments, the cast (co)polymeric component of the heat-treated principal film comprises a non-oriented polyolefin (co)polymer. In certain presently-preferred embodiments, the polyolefin (co)polymer is an ethylene acrylic acid copolymer.

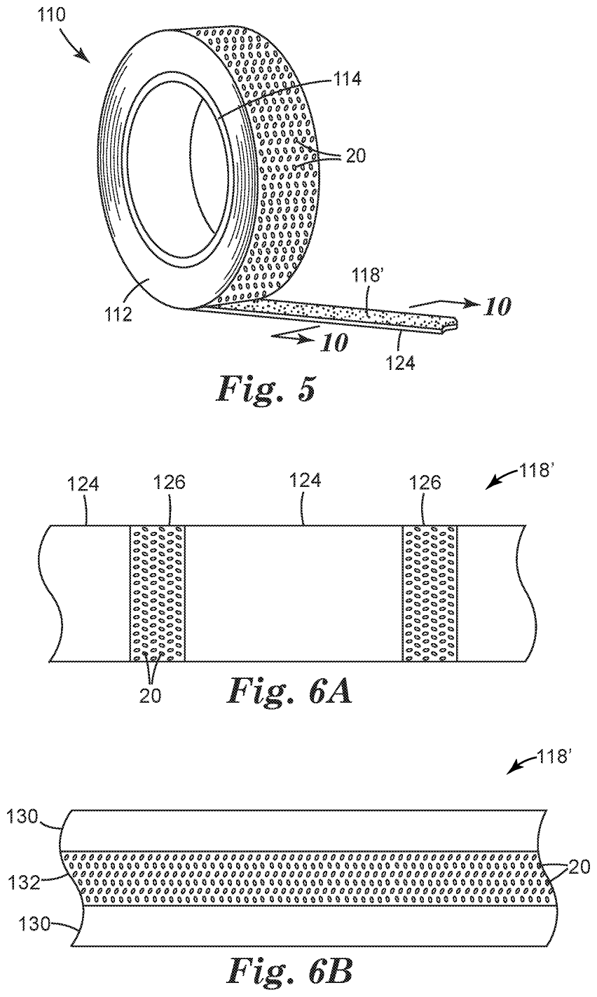

FIG. 5 shows an illustrative roll of adhesive tape 112 comprising the heat-treated principal film precursor 118′ and optionally comprising the heat-treated principal film 110 of the present disclosure. Adhesive tape 112 is wound upon itself into roll form on an optional core 114. Adhesive tape 112 comprises a cast, preferably non-oriented, flame impingement heat-treated principal film precursor 118′ comprising a plurality of modification zones 20 and adhesive layer 124. It will be understood by one of ordinary skill in the art that adhesive layer 125 may e applied to either one or both major surface of heat-treated principal film precursor 118′. Preferably, substantially all of the central portions of the modification zones 20 comprise perforations or openings in the film, which advantageously makes the film impermeable to liquids and permeable to vapors, such as air and/or water vapor.

Perhaps the most widely used oriented (co)polymer backing film for adhesive tapes is biaxially oriented polypropylene (BOPP). BOPP film based adhesive tapes are widely used as for example carton, label and box sealing tapes (such as 3M® SCOTCH® Box Sealing Tape 373, 3M Co., St. Paul Minn.). Such tapes are popular because of their good strength, water resistance, and low cost. Other typical tapes employ oriented poly(ethylene) terephthalate (PET) such as 3M® Polyester Tape 850, 3M Co. Both BOPP and biaxially oriented polyester (BOPET) are semi-crystalline (co)polymers that may be used advantageously as a carrier film in combination with the heat-treated principal film in an adhesive tape backing.

In some exemplary embodiments, some of the central portions of the modification zones 20 are closed and thus do not provide an opening in the film. In certain such embodiments, a majority (i.e., more than 50% by number) of the central portions are open, and a minority (i.e., less than 50% by number) of the central portions are closed, which advantageously makes the film semi-permeable to vapors, such as air and/or water vapor.

### Hand-Tearability and Other Advantages

The use of (co)polymeric heat-treated principal films as backings for adhesive tape applications as enabled by the present disclosure can yield tapes offering several distinct advantages.

Adhesive tapes are widely used for bonding, joining, or masking applications. An essential aspect of such adhesive tapes is the presence of a tape backing, to which self-adhesive and release coatings are affixed. It is essential to the use of an adhesive tape that the adhesive tape backings be capable of dispensing using a tool or tearing by hand to permit separation of useful lengths of tape from the roll. Especially in the area of masking tape applications, it is essential that a desired portion tape be readily torn by hand directly from the adhesive tape roll without the use of any tools or tape dispensing equipment. This enables the flexible, fastest use of the masking tape. As used herein, hand tear-ability refers to the ability of the tape to be torn by hand, or, hand tear-ability, as the ability of an average person to be able to tear a length or sheet of said backing readily with only reasonable and not undue effort. In some cases, it is desirable to be able to apply a sharp force quickly to ‘snap’ the tape into a useful length.

Historically adhesive masking tapes have been constructed with paper backings to facilitate handling and application, especially tearing by hand. Because of the inherent fragility and porosity of paper tape backings, such backings must be modified by coating with one or more (co)polymeric materials (e.g., barrier coats, binders, saturants, and the like) in order to confer desired strength, elasticity, and ability to withstand exposure to and hold out liquid coatings. Such coatings are usually applied in one or more coating operations, followed by curing or drying to fix the coating in place. This necessitates the use of a multi-step coating process line to enable the paper treatment operations followed by the applications of release and adhesive coatings to produce the desired product. Alternatively, precoating barrier coats, saturants and binders to the paper may occur in a separate operation prior to adhesive coating.

Even with the addition of barrier coats, binders and saturants, there are distinct disadvantages to use of paper backings for adhesive masking tape construction. Paper backings are inherently unstable when exposed to water or ultraviolet light and tend to shred when used in applications requiring “wet sanding,” or sanding with water, typically utilized in such industries as automotive painting. Paper backings do not tear in a straight tearing fashion, tending instead to tear at varying angles, known as slivering, and to leave shredded edges where torn. Many modern paper based adhesive masking tapes are produced using calendared or specially smoothed paper backings, which enable more uniform paint lines once removed. Still, since paper is composed of bonded paper fibers the paint lines thus formed are typically not as sharp as would be the case for a (co)polymeric tape backing; such paper backings are usually thicker than (co)polymeric film backings.

Moreover, paper backed tapes are typically too stiff and lack sufficient elongation to permit application in smooth curved manner (i.e., bending in the x-y dimension so as to form a curved paint line on a flat surface). Typically, paper-backed tapes have an elongation of less than about 25%, and in some instances less than 15%, making them unsuitable for masking many desired configurations. Finally, the paper-based masking tapes can have a relatively high production cost due to the requirement to apply the barrier, binder and saturant coatings. It should be mentioned that each such step also leads to waste either in terms of solvent removal and mitigation or in terms of thermal requirements to dry said coatings.

(Co)polymeric films, especially polyolefin based (co)polymeric films, are typically moisture and water insensitive, have typically low profiles, high strength, good conformability and low cost. However, except for several particular types of (co)polymeric backing, most (co)polymeric adhesive tapes are difficult or impossible to tear hand without the use of a tool or tape dispensing blade.

Thus, one of the advantages of adhesive tapes using the heat-treated principal films of the present disclosure as a backing is that the tear strength of the adhesive tape may be reduced to a more useful magnitude. Preferably, the heat-treated principal films of the present disclosure are hand-tearable. By hand-tearable, we mean that the heat-treated principal film has one or more segments have a tear strength of about 100 g_{f}/mil-thickness or less, in some embodiments about 70 g_{f}/mil-thickness or less, and in certain embodiments, about 55 g_{f}/mil-thickness or less.

Additionally, in some embodiments, it has been found that backing members comprised of heat-treated principal films as described herein (i.e., raised rims protruding from the first major face of the backing in modification zones) can enable release from the adhesive of overlying tape portions or sheets from underlying portions without use of a release coating on the first side of the backing or an intervening removable release liner. Such rims are of sufficient height to enable the finished tape to be unwound without excessive force, tearing of the backing, or cohesive failure of the adhesive.

By eliminating the need for such coatings or liners, the present disclosure enables significant simplification of tape manufacture and use because no coating steps, drying ovens, solvent recovery systems, or radiation curing processes, as are typically involved with use of release coatings, are necessary. Elimination of solvents eliminates volatile organic compounds, and also eliminates the energy to run ovens such that the overall tape manufacturing process is more efficient. The absence of oven drying causes less thermal damage to oriented film substrates, simplifies web handling operations, and enables use of a much smaller space for manufacturing operation.

The rims of melted (co)polymer on the first major face of the heat-treated principal film enable the smooth and easy unwind of tapes made therefrom in accordance with the disclosure. It is thought that the maximum height of the rims is a critical parameter enabling adhesive release and subsequent unwind because the highest points on the rim are the locations that hold the pressure sensitive adhesive farthest from the primary surface of the hand-tearable film (i.e., the portion of the first face or side between perforations and their rims). Adhesion between the highest points of the melted rim of modification zones formed with a fuel-rich flame and the adhesive will be limited because the small area of contact between the rim and the adhesive and the low extent of oxidation of the rim.

The configuration and arrangement of the modification zones provide a heat-treated principal film that can be readily torn in straight or substantially straight lines yet has a sufficient tensile strength to be used as a backing member in adhesive tapes. Tear initiation and propagation parameters of tapes can be controlled as desired by controlling the arrangement and geometry of the modification zones.

The heat-treated principal film can typically be torn by hand (is hand-tearable) in at least one direction and can be formed such that it is hand-tearable in two perpendicular directions. The heat-treated principal films of the disclosure can have relatively low tear initiation energy and relatively high tear propagation energy as compared to similar (co)polymeric films that are not modified to possess modification zones in accordance with the disclosure. In addition, the modification zones of heat-treated principal films of the disclosure allow tearing of the films in substantially straight lines compared to similar (co)polymeric films that have not been modified in accordance with the disclosure. The modification zones allow such improved tear properties without excessively weakening the tensile strength of the film.

Through control of film properties (e.g., film thickness, etc.) and differential heating process conditions and equipment (e.g., film speed and thickness, arrangement, and shape of heating zones, etc.), the position, spacing, and shape of modification zones may be controlled as desired (e.g., to optimize tear initiation and propagation forces, tear directionality, conformability, etc.). For instance, the modification zones may be substantially circular, oval, diamond-shaped, triangular, or of some other geometry, and may be arranged in an ordered homogeneous array or in an irregular manner (e.g., where spacing or relative position or both are varied).

In some embodiments where easier tear is desired for an adhesive tape backing comprising a flame impingement differentially heat-treated principal film of the present disclosure, the modification zones in the (co)polymeric film are typically preferably non-circular and have a length at least 1.25 times their width, and typically at least 2 times their width. Although different individual modification zones across the principal film may exhibit variation, with their respective central portions and surrounding rim portions varying somewhat in size, they typically each have a major axis and a minor axis. The major axis is a line along the length of the modification zone, and the minor axis is a line along the width of the modification zone (e.g., to create a herringbone pattern). In one implementation, a line projected along the major axis of each modification zone passes through an adjacent second modification zone. In specific implementations a line projected along the major axis of each modification zone passes through an adjacent modification zone along or parallel to the minor axis of the adjacent modification zone.

In accordance with the disclosure, the modification zones can be arranged in a fashion such that they promote easy tearing of the film in the down-web or machine direction (MD) and in the cross-web or transverse direction (TD). The modification zones sufficiently preserve the tensile strength of the film that it may be sufficiently robust to serve as a tape backing while imparting desirable straight line tearing characteristic to the film such that it can be used conveniently as a tape backing. The disclosure enables formation of hand-tearable sheets and tapes using (co)polymeric films as backings that would otherwise exhibit undesirable tear and tensile properties such as slivering when peeled from a roll or surface to which they have been applied (e.g., such as with masking tape), unduly high tear initiation force, unduly high tear propagation force, tendency to result in jagged or non-straight tear lines, etc. Adhesive tapes made using films of the disclosure can provide superior tear properties such as controlled tear propagation to avoid slivering, splitting, and unpredictable failure; uniform texture for eased of handling and application, and the ability to visually indicate proper adherence by serving as a visual indicator of adhesive wet-out. The latter performance parameter is particularly valuable for embodiments where films of the disclosure are used as backings for masking tapes.

In some exemplary embodiments the modification zones are arranged in an ordered array. In other exemplary embodiments, the modification zones are arranged in a random manner. In certain exemplary embodiments, the modification zones have a substantially similar individual configuration. In other exemplary embodiments, the modification zones have a varied individual configuration.

In certain exemplary embodiments, the heat-treated principal film is provided in a rolled form (e.g., a rolled bare sheet or adhesive-backed rolled film). In some embodiments, the heat-treated principal film may consist of a single homogenous segment (i.e., a sheet comprising a uniform array of modification zones). In other embodiments, the heat-treated principal film may comprise two or more segments where the segments differ in nature or even presence of modification zones.

In certain such embodiments, the heat-treated principal film has a first segment having a first array of a plurality of modification zones and a second segment having a second array of a plurality of modification zones, wherein the first array differs from the second array in one or more characteristics. In some such embodiments, the characteristics are selected from the group consisting of the following: (1) an average distance between adjacent modification zones, (2) a shape of the modification zones, (3) a dimension of the modification zones, and (4) an average thickness of the rim portions.

If desired, an adhesive tape may be made wherein the heat-treated principal film has first segment having a first array of a plurality of modification zones and a second segment having a second array of a plurality of modification zones wherein the first array differs from the second array in one or more characteristics. This can be achieved by using a backing roller having corresponding arrays of depressions to form the multiple segments simultaneously or forming the respective segments of modification zones sequentially.

As desired, respective arrays of modification zones may be formed that include differences in one or more of the characteristics selected from the group consisting of: (1) average distance between adjacent modification zones, (2) shape of modification zones, (3) dimension of modification zones, and (4) average thickness of rim portions.

Thus, in further exemplary embodiments, the heat-treated principal film has a first segment having an array of a plurality of modification zones and a second segment which is substantially free of modification zones.

FIG. 6A shows an illustrative embodiment of an adhesive article of the disclosure wherein the heat-treated principal film precursor 118′ is an elongate tape comprising a plurality of segments 124 which do not have modification zones 20 interspersed with segments 126 having modification zones in accordance with the disclosure. In a tape application, such configuration may be used to render the film more easily conformed or separable at discrete lengths, corresponding to segments 126. The segments may be of desired relative size and spacing.

FIG. 6B shows another illustrative embodiment of an adhesive article of the disclosure wherein heat-treated principal film precursor 118′ is an elongate tape comprising a central segment 132 with adjacent segments 130 which do not have modification zones 20. In a tape configuration, such configuration may be used to render the film more easily conformable in an elongate middle portion (e.g., to bend around a wall corner). As will be understood, heat-treated principal films of the disclosure may be made with other desired configurations of one or more first segments having an array of modification zones 20, and one or more other segments having no modification zones 20 or arrays of modification zones 20 that differ from that of the first segment(s). In this manner, heat-treated principal films having varying properties such as tear strength, conformability, etc. at different locations and in different configurations may be realized in accordance with the disclosure.

In certain advantageous embodiments, the central portions and complementary surrounding rim portions are typically circles, elongate ovals, rectangles, or other shapes arranged in a fashion such that the major axis of each modification zone intersects adjacent modification zones or passes near adjacent modification zones to provide optimum tear properties.

A feature of tapes of the disclosure is the modification zones in the backing each have a raised ridge or rim formed during flame impingement. Previously, this rim has been observed to provide enhanced tear properties of the perforated film and to also impart slight textures that cause the film to more closely resemble a conformable material. As discussed above, such raised ridges or rims have, in some particular embodiments, been surprisingly found to eliminate the need for use of a release coating or liner in an adhesive tape construction.

As discussed in U.S. Pat. No. 7,037,100 with reference to FIG. 4 therein,
“The perforation pattern formed in polymeric film 14 has a strong influence on the tear and tensile properties of the cloth-like films and tape backings of the disclosure. In reference now to FIG. 4, a portion of an enlarged layout of a typical perforation pattern 28 is shown, with the machine direction oriented up and down, and the transverse direction oriented left to right. Depicted perforation pattern 28 comprises a series of rows of perforations, identified as a first row having perforations 1a, 1b, and 1c; a second row having perforations 2a, 2b, and 2c; a third row having perforations 3a, 3b, and 3c; a fourth row having perforations 4a, 4b, and 4c; and a fifth row having perorations 5a, 5b, and 5c. Typically the perforations form a pattern extending along most or all of the surface of a film, and thus the pattern shown in FIG. 4 is just a portion of one such pattern.”

U.S. Pat. No. 6,635,334 (Jackson et al.) and U.S. Pat. No. 7,138,169 (Shiota et al.) disclose a number of patterns that might be used for modification zones in a heat-treated principal film of the present disclosure to attain desired resultant tear, crease, folding, and other physical properties of the resultant tape. In accordance with the present disclosure, such patterns may be used to form closed modification zones (i.e., central portions of the modification zones do not penetrate completely through the film in the manner of the perforations disclosed in the prior art).

Without wishing to be bound by any theory, it is believed that the density of the modification zone pattern contributes to both the conformability and fold-ability of the films and tapes of this disclosure and the tear and tensile properties, and that lowering the density or changing its distribution in such a way as to provide channels, along either the machine direction (MD) or the cross-web or transverse direction (TD) or both, in which a propagating tear might encounter no modification zones, results in decreased conformability, and less desirable tear and tensile properties along the direction of such a modification free channel, compared to the most preferred pattern. Tapes of this disclosure conform to substrates such as boxes, containers, skin, automotive parts and panels, and other materials thereby enabling the intimate contact of the pressure sensitive adhesive with the part or substrate and thus increasing the adhesion between the tape and the substrate. In addition, adhesive tapes of present disclosure can be folded so as to produce a soft paint edge when used in a typical paint spraying operation, as is well known for comparable paper-backed masking tapes.

Also, it is believed that the raised rim portion around each central portion serves to blunt propagation of the tear, resulting in better control of the tear by hand, and increase in tear propagation force (relative to that of unperforated film). The tear initiation force, however, is reduced, relative to that of precursor film, especially for the most preferred pattern, because the modification zone density guarantees that the edge of any film or tape so constructed will have modification zones either at or extremely near the edge. Surprisingly, it has been found that tapes made as described herein can exhibit very sharp and uniform paint lines when used in masking applications, even with the as-described modification zones and differential thickness. It is believed that such films and the resultant tapes have superior conformability in the thickness or z-axis dimension, thereby allowing improved contact to the substrate to which they are adhered. Therefore, for the purposes of tear initiation, the inventive films and tapes behave similarly to notched films but without the occurrence of significant slivering, which is a problem for paper-backed masking tapes especially when utilized in a wet environment.

The flame impingement differentially heat-treated principal films provided by the present disclosure may, in some embodiments, uniquely provide various desired combinations of attributes, including, in certain exemplary embodiments (e.g., convenient hand tear-ability, inherent moisture and water resistance, resistance to slivering, straight-line tear propagation, low profile, low cost, high conformability that is, ability to be formed into a radius with a continuous flat outer or convex edge due to both the inherent flexibility of (co)polymeric films and the additional ‘give’ flame impinged films have due to the thinned central portions). Additionally, the heat-treated principal films provided by the present disclosure generally do not require use of barrier, binder or saturation coatings when used in adhesive tape applications.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted.

Precursor (Co)Polymer Films

An approximately 50 micron thick coating of poly(ethylene-co-acrylic acid) (Primacor 3440 resin, available from Dow) was applied via extrusion coating to the surface of an approximately 50 micron thick film of biaxially oriented polyethylene terephthalate (00990197, available from 3M Company, Decatur, Ala.) to obtain the precursor films described in Examples 1, 2, and Comparative Example 3. A two-feet-long section of the poly(ethylene-co-acrylic acid) layer was delaminated from the above construction for preparing the precursor film used in Comparative Example 2. An approximately 66 micron thick polypropylene film made by an extrusion casting process (3M Company, Knoxville Iowa) was used to prepare Comparative Example 1.

### Test Methods

Constrained Thermally Induced Elastic Recovery Test

The thermally induced elastic recovery stress of test specimens were measured using a TA Instrument model RSA G2 Dynamic Mechanical Analyzer (TA Instruments, New Castle, Del.) in tensile mode.

Test specimens were cut along the major axis of film direction for measurements; practically this means the transverse film direction (TD) at a dimension of 6.2 mm in the MD and 25 mm in the TD. Specimens were clamped with a fixed strain of 1% so that the testing strip was positioned flat and even. Specimens were first conditioned at 30° C. for 2 mins, and then subjected to heating from 30° C. to 190° C. at the rate of 3° C./min. Under these conditions of fixed clamping, upon heating an axial retractive or elastic recovery force is generated with increasing temperature as the crystalline or other hard phase segments of the film soften and melt. In the tensile mode of the DMA, the axial force at a fixed strain reflects the recovering stress released during the heating. The plot of normalized stress over temperature shows the stress change during the elastic recovery caused by heating. The normalized stress is obtained by normalizing axial force by the area of the film cross section. Because the thermally induced stress is exerted on the specimen clamps in the direction of strain, the values reported are negative (that is, the test specimen exert a pull or tensile retractive force on the force transducers to which the clips are affixed).

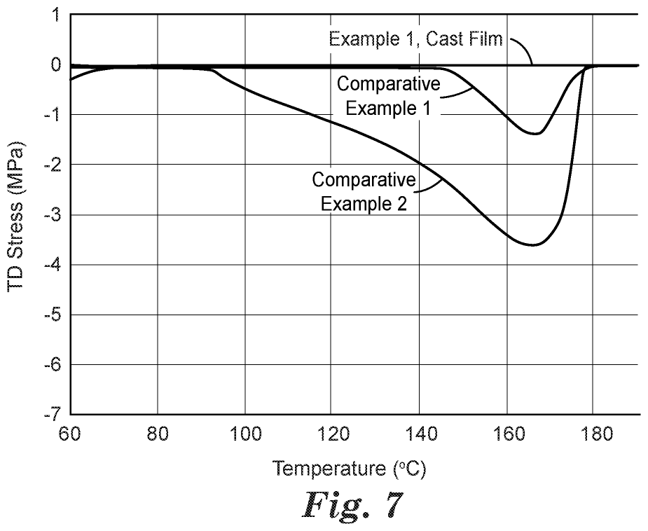

FIG. 7 is a graph showing the lack of constrained elastic recovery stress in a non-oriented cast precursor film according to an embodiment of the present disclosure, compared to the constrained elastic recovery stress demonstrated in comparative biaxially-oriented polypropylene films described in WO2016105501 and suitable for use as carrier films, prior to differential heat-treating.

Optical Microscopy Test Method

The optical microscopic images of the test samples were taken using Olympus optical microscope with a digital camera (Model no. BX51TRF). Test specimens were cut into approximate dimension of 25 mm in width and 75 mm in length. Specimens were mounted on a glass slide and placed under the objective of the microscope. The images were captured under 2.5× magnification.

Ink Penetration Test

For ink penetration test, the samples were cut into sheets of approximate dimensions 305 mm by 150 mm. Sample sheets were overlaid on a A4 size (210×297 mm) printing paper. A king size Sharpie permanent marker was used to apply the ink on the top side of sample sheet (side not facing the paper). Ink penetration was reported after analyzing whether the ink penetrated through the sample sheet to the paper.

### Flame Impingement Differential Heat-treating Process

The flame impingement differential heat-treating apparatus shown in FIG. 1 was used to produce the Examples. The flame impingement differential heat-treating apparatus as generally shown in FIG. 3 of U.S. Pat. No. 7,037,100 was used to produce the Comparative Examples. The following operating conditions were used.

Compressed air was premixed with a natural gas fuel (having a stoichiometric ratio of 9.7:1 and a heat content of 37.7 kJ/L) in a venturi mixer (from Flynn Burner Corporation, Mooresville, N.C.) to form a combustible mixture. The flow rates of air and natural gas were measured with thermal mass flow meters (from Fox Thermal Instruments, Inc., Marina, Calif.), and the flow rates of natural gas and air were controlled with servo-motor-driven needle valves (from Flynn Burner Corporation). All flow rates were adjusted to achieve a flame equivalence ratio of 0.97 (air/fuel ratio of 10/1) and a normalized power of 820 W/cm² of burner area (13,500 Btu/hr-in. of burner length). The combustible mixture passed through piping to a ribbon burner of the type described in U.S. Pat. No. 7,635,264, comprising a 30.5 cm long×1.9 cm wide, 8-port corrugated stainless steel ribbon mounted in a water-cooled aluminum housing (from Flynn Burner Corporation).

The burner was mounted adjacent to a 35.5 cm diameter, 46 cm face-width, chilled steel backing roller (from American Roller Company, Union Grove, Wis.). The temperature of the backing roller was controlled by a 240 L/min recirculating flow of water at a temperature of 10° C. The face of the backing roller was plated with 0.5 mm of copper, the central 29 cm of the face of the roller was etched with the perforation pattern shown in FIG. 6 of U.S. Pat. No. 7,037,100, and then the entire face was coated with 0.01 mm of chrome (by Custom Etch Rolls Inc., New Castle, Pa.). Filtered, compressed air at a pressure of about 35 kPa/m² (5 psig) was blown onto the backing roller to controllably reduce the amount of water condensation on the central, patterned portion of the backing roller. The distance between the face of the burner housing and the face of the backing roller, which is the D distance in FIG. 4 of U.S. Pat. No. 7,037,100, was adjusted to 11 mm. The E distance in FIG. 4 of U.S. Pat. No. 7,037,100 was equal to 3 mm.

The precursor films were guided by idler rolls to wrap around the chilled backing roller and over the patterned portion of the roller and passed through the flame impingement process at a speed of 15-40 m/min. The upstream and downstream tension of the film was maintained at approximately 2.2 N/lineal cm. To insure intimate contact between the polypropylene film and the chilled backing roller, a 10 cm diameter, 40 cm face-width inbound nip roller covered with 6 mm of Arcomax 8007 elastomer (from American Roller Company, Union Grove, Wis.), was located approximately 45 degrees relative to the burner on the inbound side of the chilled backing roller. Positioned between the nip roller and the burner was a water-cooled shield maintained at a temperature of 38° C. with recirculating water. The nip roller-to-backing roller contact pressure was maintained at approximately 50 N/lineal cm.

### Flame Impingement Differential Heat-Treatment of Exemplary Cast (Non-Oriented) Films

An 8-port, ¾ in.-downweb ribbon-burner as described above was used for the Comparative Examples and Examples. Comparative Examples C1, and C2 and Example 1 were generated from 12 in.-wide films with a circle-patterned backing roller. Example 2 was generated from a 6 in.-wide web with a herringbone-patterned backing roller. Comparative Example C2 was generated using 2 ft×12 in. section of EAA film spliced between a roller of 12 in.-wide BOPP film.

All of these Comparative Examples and Examples were prepared with total tensions ranging between 10 and 15 lbs. Flame conditions (power, equivalence ratio, gap) and backing-roller temperature were kept constant for finished sheets of about 30 to about 40 micrometers in thickness of the indicated (co)polymers were formed and wound onto a roller. The web speed was varied to find the desired process window of perforation based on the given input film construction. The process conditions used for these Comparative Examples and Examples are summarized in Table 1.

TABLE 1
Flame Treatment Conditions for Cast Films

| | | | | | Comparative |
|---|---|---|---|---|---|
| | | | Example 1 | Example 2 | Example C3 |
| | Comparative | Comparative | (Cast EAA | (Cast EAA | (Cast EAA |
| | Example. C1 | Example C2 | on PET | on PET | on PET |
| Conditions^{a} | (Cast PP) | (Cast EAA)^{b} | Carrier Film) | Carrier Film)^{c} | Carrier Film) |
| Substrate Thickness (mil) | 2.6 | 2 | 2 (EAA) | 2 (EAA) | 2 (EAA) |
| | | | 2 (PET) | 2 (PET) | 2 (PET) |
| Layer Facing Flame | PP | PP | PET | PET | EAA |
| Flame Power (BTU/hr.-in.) | 13,500 | 13,500 | 13,500 | 13,500 | 13,500 |
| Air/Fuel Ratio | 10 | 10 | 10 | 10 | 10 |
| Burner/Roller gap (mm) | 11 | 11 | 11 | 11 | 11 |
| Backing Roller | 50 | 50 | 50 | 50 | 50 |
| temperature (° F.) | | | | | |
| Web (Film) Speed (m/min) | 40 | 40 | 20 | 15 | 20 |

^{a}Conditions are for the flame impingement differential heat-treatment apparatus described above.
^{b}Cast EAA (2 ft) was spliced in with 1.6 mil BOPP;
^{c}Example 2 was heat-treated with a herringbone pattern on the backing roller and the film width was 6″, all other samples were heat-treated with the circle-pattern with 12″ film width.

Comparative Examples C1 and C2 illustrate the difficulty in processing cast films through the differential flam treating process.

### Comparative Example C1: Cast PP Film without Carrier Film

A 2.6-mil cast (non-oriented) polypropylene (PP) film not capable of thermally-induced self-forming as described above was subjected to the flame impingement heat-treating process shown in FIG. 1 and described above, except that no carrier film was used between the chilled back-up 202 and the precursor film 100.

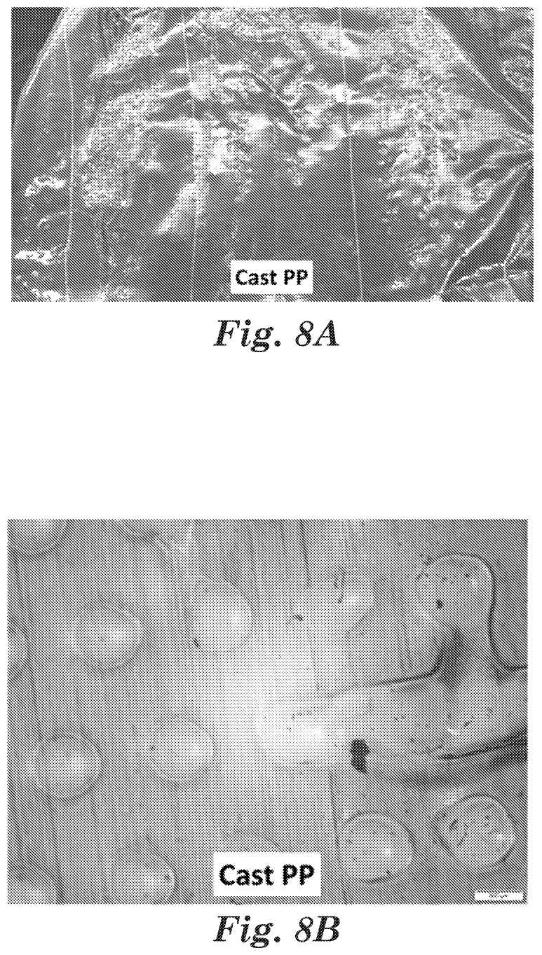

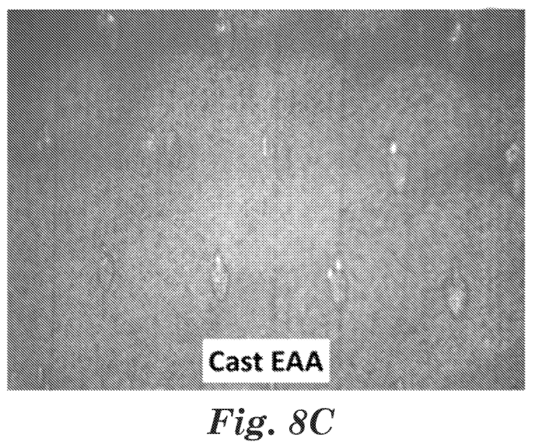

FIG. 8A shows a micrograph of a portion of the heat-treated principal film of this Comparative Example. The processed cast PP film exhibits significant visible damage and thermal wrinkles. The micrograph of FIG. 8B shows that the rim structure on the cast PP is not fully formed and lacks uniformity. The micrographs of FIGS. 8A and 8B highlight some of the challenges associated with processing a cast film in the flame-impingement differential heat-treating process. Web-handling of the cast films through the flame perforator is often difficult due to web breaks and tensioning issues.

### Comparative Example C2: Spliced Cast EAA Film without Carrier Film

A 2 ft-long sample of 2 mil EAA purposefully delaminated from an EAA-PET construction as described above was used as the input web to prepare this example. The 2 ft-long sample was spliced into a roll of BOPP film to transport the film through the differential heat-treating process. Processing splices through a high-powered flame perforator unit is a challenging task. In this example, as soon as the EAA material reached the flame zone it melted and the web broke. FIG. 8(C) shows a micrograph of a portion of the heat-treated principal film of this Comparative Example under 2.5× magnification; the female pattern of the backing roller hardly shows up in the image.

### Example 1: EAA Precursor Film on PET Carrier Film with PET Exposed to the Flame

In this example, 2 mil EAA cast film on a 2 mil oriented PET film as described above was perforated with the PET facing the flame under the conditions listed in Table 1. In this construction, the PET layer was prepared by stretching biaxially using a tenter process and then the PET was coated with 2 mil EAA using extrusion coating as described above. The stretching of the PET layer introduces internal stresses in that layer that enables the flame impingement differential heat-treating process to produce openings or perforations extending through the major faces of the precursor film and carrier film through heat-induced stress relaxation.

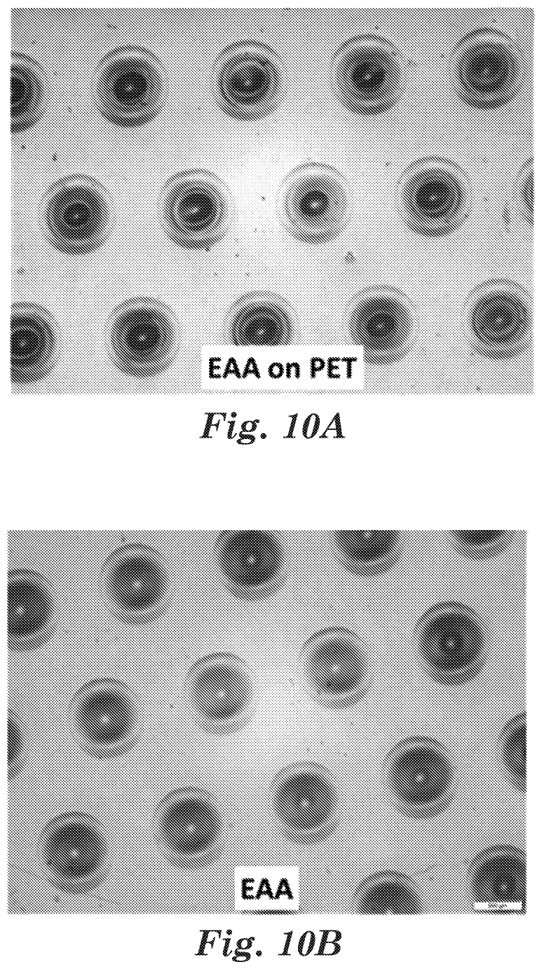

FIG. 10A shows a micrograph of a portion of the heat-treated principal film on the PET carrier film of this Example. As shown in this micrograph, this heat-treated principal film exhibits a uniform pattern of treatment zones on the surface of the film construction. FIG. 10A clearly shows the rims and central regions of the created in the flame impingement differential heat-treating process carried out using an oriented carrier film. This is in contrast to the heat-treated films shown in the photographs of FIGS. 8A-8C, which were produced without using an oriented carrier film.

Upon delaminating the EAA heat-treated principal film from the carrier film, the heat-treated principal film retains the rims produced during the flame impingement differential heat-treating process, as shown in the micrograph of FIG. 10B.

To test for the openness of the central portions of the treatment zones, the heat-treated principal film of Example 1 was subjected to the Ink Penetration Test as described above. Ink was applied to a major face of the EAA heat-treated principal film and was found not to penetrate through the EAA heat-treated principal film, indicating that there are no holes extending through the major faces of the EAA heat-treated principal film after the flame impingement differential heat-treatment.

The heat-treated principal films of Comparative Examples 1 and 2 and Example 1 were also subjected to the Elastic Recovery Test as described above. FIG. 7 shows the lack of constrained elastic recovery stress in the heat-treated principal film of Example 1, compared to the significant constrained elastic recovery stress exhibited for the heat-treated principal films of Comparative Examples 1 and 2.

### Example 2: EAA Precursor Film on PET Carrier Film with PET Exposed to the Flame

In Example 2, the same set-up as Example 1 was used except that the backing-roller pattern was changed from circle-pattern to a herringbone-pattern.

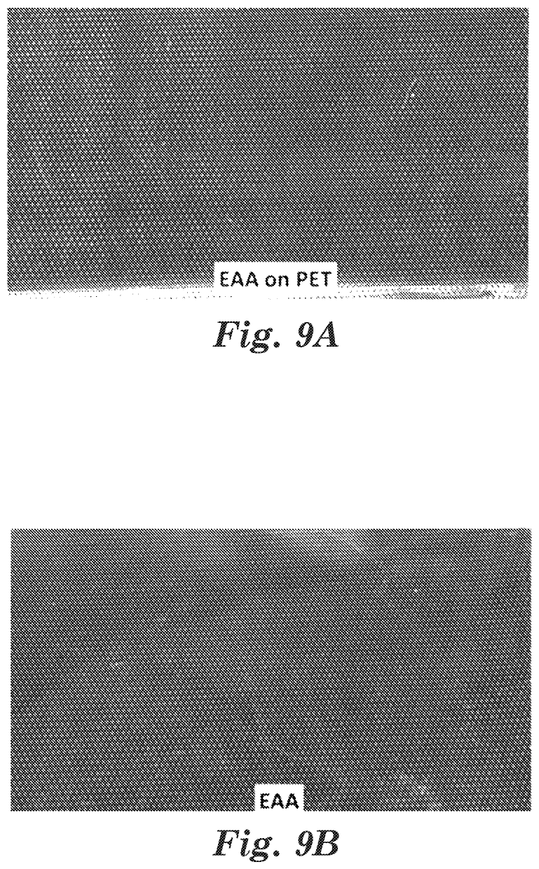

FIG. 9A shows a micrograph of a portion of the heat-treated principal film on the PET carrier film for this Example. As shown in the micrograph, this heat-treated principal film exhibits a uniform pattern of perforated (i.e., open) treatment zones in the heat-treated principal film.

Upon delamination, the EAA layer retained the pattern of the holes and the rims. FIG. 9B is a photograph of a plurality of modification zones with an open, perforated central portion extending through the major faces of the heat-treated principal film.

The heat-treated principal film was subjected to the Ink Penetration Test as described above. Ink was found to penetrate through the major faces of the EAA heat-treated principal film after the flame impingement differential heat-treatment, thereby showing the presence of openings or holes extending through the major faces of the heat-treated principal film.

### Comparative Example C3: EAA Precursor Film on PET Carrier Film with EAA Exposed to the Flame

Comparative Example C3 used the same flame-perforation conditions as Example 1 but with the EAA carrier film facing the flame. The heat-treated principal film on the PET carrier film exhibited severe damage and thermal wrinkles when the EAA precursor film was exposed to the flame. This is not the case when the PET carrier layer was exposed to the flame, as shown in FIGS. 9A-9B. The physical damage to the EAA film may be due to the lower melting point of EAA (around 105° C.) as compared with PET (260° C.) and PP (160° C.). FIG. 6(c) also shows that even though some rims/holes can be created in the EAA-PET construction, the process is very non-uniform.

Table 2 summarizes properties of the Comparative Examples and Examples. Comparative Examples C1 and C2 illustrate that creating a uniform pattern of holes/rims on cast PP or cast EAA films is challenging due to lack of internal stresses in cast films. Typically, perforating such films results in thermal damage and wrinkles. Examples 1 and 2 illustrate that a substantially uniform pattern of rims with or without holes can be created on cast films by using an oriented carrier film such bi-axially stretched PET film. Example 1 shows that closed perforation can be achieved using this method, while Example 2 shows that open perforations are also possible using this method. Comparative Example C3 illustrates that, for this particular EAA on PET construction, it is important to orient the film such that the PET layer is directly exposed to the flame, as exposing the EAA layer directly to the flame results in thermal damage to the film and wrinkles.

TABLE 2
Properties of Flame Impingement Heat-treated Cast Precursor Films

| Example or | | Layer | Internal | Thermal | | |
|---|---|---|---|---|---|---|
| Comparative | Film | Facing | Stresses in Film? | Damage or | | |
| Example | Construction | Flame | (PP or EAA) | Wrinkles? | Rims? | Holes? |
| C1 | Cast PP | PP | No | Yes | No | No |
| C2 | Cast EAA | EAA | No | Yes | No | No |
| 1 | EAA on PET | PET | No | No | Yes | No |
| 2 | EAA on PET | PET | No | No | Yes | Yes |
| C3 | EAA on PET | EAA | No | Yes | Yes | No |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

What is claimed is:

1. An article comprising a heat-treated principal film, wherein:
the heat-treated principal film comprises a cast (co)polymeric component comprising one or more (co)polymers, wherein the heat-treated principal film is not capable of thermally-induced self-forming; and further wherein the heat-treated principal film has:
first and second opposed major faces;
a land portion on the first major face; and
one or more modification zones on the first major face, each modification zone comprising a central portion and a rim portion surrounding the central portion, and wherein each rim portion is surrounded by the land portion, wherein an average thickness of each rim portion is greater than an average thickness of the land portion, further wherein an average thickness of each central portion is less than the average thickness of the land portion surrounding each modification zone, or zero, optionally wherein the first major face of the heat-treated principal film is positioned in contact with a major face of an oriented carrier film comprising a (co)polymer selected from the group consisting of polyester, polystyrene, biaxially-oriented polypropylene, and a combination thereof.

2. The article of claim 1, wherein the heat-treated principal film is not oriented.

3. The article of claim 2, wherein each rim portion has a geometric shape selected from a circle, an ellipse, or a combination thereof.

4. The article of claim 2, wherein the average thickness of the land portion of the heat-treated principal film is about 0.5 to about 3 mils (13 to 75 micrometers).

5. The article of claim 2, wherein the cast (co)polymeric component comprises a polyolefin (co)polymer.

6. The article of claim 5, wherein the polyolefin (co)polymer is an ethylene acrylic acid copolymer.

7. The article of claim 2, further comprising an adhesive layer on one or both of the first or the second major faces of the heat-treated principal film.

8. The article of claim 7, wherein the adhesive layer is discontinuous.

9. The article of claim 7, wherein the adhesive layer is on only the first major face or the second major face of the heat-treated principal film, and wherein a release coating is on at least a portion of the major face of the heat-treated principal film opposite the adhesive layer.

10. The article of claim 9, wherein the release coating is on substantially the entire major face of the heat-treated principal film opposite the adhesive layer.

11. A method for forming a heat-treated principal film, the method comprising:
(a) providing an oriented carrier film having opposed first and second major faces and comprising a molecularly-oriented (co)polymer that exhibits a relaxation temperature (Tᵣ), wherein the second major face of the oriented carrier film contacts a first major face of a principal film precursor comprising a cast (co)polymeric component that is not oriented and is incapable of thermally-induced self-forming;
(b) overlaying at least one female depression in a patterning surface with at least one modification zone of the principal film precursor and the oriented carrier film;
(c) heating the oriented carrier film in the at least one modification zone overlaying the at least one female depression in the patterning surface to a temperature above the Tᵣ, while maintaining a land portion surrounding the modification zone on the first major face of the oriented carrier film and a land portion surrounding the modification zone on the first major face of the principal film precursor at a temperature below the Tᵣ, so as to cause dimensional modification of the oriented carrier film and the principal film precursor within the at least one modification zone, thereby forming a heat-treated principal film; and
(d) cooling the at least one modification zone of the oriented carrier film to a temperature below the Tᵣ, wherein each modification zone of the oriented carrier film and the heat-treated principal film comprises a central portion and a rim portion surrounding the central portion and wherein each rim portion is surrounded by the land portion, further wherein an average thickness of each rim portion is greater than an average thickness of the land portion and wherein an average thickness of each central portion is less than the average thickness of the land portion surrounding the modification zone, or zero; and optionally
(e) separating the oriented carrier film from the heat-treated principal film.

12. The method of claim 11, wherein the heating is carried out using flame impingement or selectively directed infrared radiation on the first major face of the oriented carrier film.

13. The method of claim 11, wherein the oriented carrier film comprises a (co)polymer selected from the group consisting of polyester, polystyrene, biaxially-oriented polypropylene, and a combination thereof.

14. The method of claim 13, wherein the polyester (co)polymer is selected from the group consisting of poly(ethylene)terephthalate, poly(butylene)terephthalate, poly(trimethylene)terephthalate, poly(ethylene)naphthalate, poly(lactic acid), and combinations thereof.

15. The method of claim 11, wherein the cast (co)polymeric component comprises a polyolefin (co)polymer, optionally wherein the polyolefin (co)polymer is an ethylene acrylic acid copolymer.
